(19) United States
(12) Patent Application Publication
(10) Pub. No.: US 2007/0061365 A1
(43) Pub. Date: Mar. 15, 2007

(54) Event participant image locating, retrieving, editing and printing system

(75) Inventors: Gary Giegerich, Glenside, PA (US); Edmond J. Dougherty, Wayne, PA (US); Peter I. Michel, King of Prussia, PA (US)

Correspondence Address: AKIN GUMP STRAUSS HAUER & FELD L.L.P., ONE COMMERCE SQUARE, 2005 MARKET STREET, SUITE 2200, PHILADELPHIA, PA, 19103, US

(73) Assignee: Ablaze Development Corporation

(21) Appl. No.: 11/517,028

(22) Filed: Sep. 7, 2006

Related U.S. Application Data
(60) Provisional application No. 60/714,926, filed on Sep. 7, 2005.

(51) Int. Cl. G06F 17/00

(52) U.S. Cl. 707/104.1

(57) ABSTRACT

Event participants in attendance at a plurality of different event venues can locate, edit and print images of themselves in their respective seating locations. A venue database is provided that contains data for a plurality of venues. For each venue, the venue database includes past events that occurred at the venue for a predetermined past time period and the associated event date, a venue seating chart, event participant images captured at past events at a plurality of different seating locations, and data related to the event type for at least some of the past events. The user searches the data in the venue database to identify a past event of interest. A venue seating chart associated with the past event of interest is displayed, the user selects a seating location on the seating chart, and one or more event participant images captured at the past event of interest at the selected seating location is displayed. The user selects one or more of the images and applies a plurality of different image editing functions to the image via a user interface display screen. The edited images can be stored and/or printed.

### CROSS REFERENCE TO RELATED APPLICATION

This application claims the benefit of U.S. Provisional Patent Application No. 60/714,926 filed Sep. 7, 2005 entitled “Aerial Support Structure and Method for Image Capture.” This application is related to copending U.S. application Ser. No. 11/470,461 filed Sep. 6, 2006 entitled “Aerial Support Structure and Method for Image Capture,” which is incorporated herein by reference.

### BACKGROUND TO THE INVENTION

Spectators who attend live events often desire to memorialize the events by taking photographs of themselves at the event. However, for a variety of reasons, many spectators do not take photographs.

U.S. Pat. No. 7,077,581 (Gluck), incorporated herein by reference, describes an image capture system which takes images of spectators in their respective seating areas at a live venue, indexes the images to their respective seating locations in the venue, and then makes the images available to the spectators via a plurality of workstations at the venue. The images may be edited by the spectator using software such as Adobe® Photoshop® prior to being printed. The spectator's seat number may be used to search for the images taken of spectator's seating area.

U.S. Patent Application Publication No. 2003/0086123 (Torrens-Burton), incorporated herein by reference, also describes a similar type of image capture system and kiosk-based image printing station. A home delivery system is also described so that the spectator can search for and print out images via a browser or the like.

Despite the disclosure of numerous different spectator-based image capture systems, there is still a need for additional capabilities in such systems. The present invention fulfills such a need.

### BRIEF SUMMARY OF THE INVENTION

Different preferred embodiments of the present invention provide at least the following capabilities:
1. Search across a plurality of different event venues for spectator images.
2. Store and recreate a plurality of different image editing functions applied to an image.
3. Electronic selection of framing options.
4. Electronic imposing of a corporate logo border around the image.
5. Selection of higher payment levels to print out images with no corporate logo borders or watermarks.
6. Automatic creation of collages (auto-collage).

### BRIEF DESCRIPTION OF THE DRAWINGS

The foregoing summary, as well as the following detailed description of preferred embodiments of the invention, will be better understood when read in conjunction with the appended drawings. For the purpose of illustrating the invention, there is shown in the drawings embodiments which are presently preferred. It should be understood, however, that the invention is not limited to the precise arrangements and instrumentalities shown.

FIGS. 1-4 are entity relationship diagrams for one preferred embodiment of the present invention.

FIGS. 5-26 are data tables for one preferred embodiment of the present invention.

FIG. 27 is a schematic block diagram of a system architecture for one preferred embodiment of the present invention.

FIG. 28 is a flowchart for an image loading/displaying process for one preferred embodiment of the present invention.

FIGS. 29-57 are user interface display screens for one preferred embodiment of the present invention.

FIGS. 58-63 are sample pictures that appear in selected user interface display screens.

FIG. 64 is a flowchart for an image watermark process for one preferred embodiment of the present invention.

FIG. 65 is a flowchart for a corporate logo border image process for one preferred embodiment of the present invention.

FIGS. 66-67 are user interface display screens for creating collages in accordance with one preferred embodiment of the present invention.

### DETAILED DESCRIPTION OF THE INVENTION

Certain terminology is used herein for convenience only and is not to be taken as a limitation on the present invention.

The present invention is described in the context of a website referred to as Wavecam™, provided by Live Event Media, LLC. Users interface with the Wavecam website via an electronic network, such as the Internet. However, the functionality provided by the website may also be made available via a kiosk or other electronic interfacing media.

The references below to a “user” refers to a participant in attendance at an event venue. The user is thus similar to a “spectator” or “fan.” Alternatively, the “user” may not have been in attendance at the event, but may be interested in spectator images of actual attendees.

Many different techniques can be used to associate camera images with seating locations of a venue for purposes of indexing the images. U.S. Pat. No. 7,077,581 (Gluck) describes numerous indexing schemes, any of which may be used in the present invention. The indexed images may be uploaded to a central database (website) via a SOAP interface.

I. Overview of Invention Embodiments

a. Search across a plurality of different event venues for spectator images.

In this embodiment, a user locates, edits and prints images of event participants in attendance at a plurality of different event venues. This scheme includes at least the following steps:
1. A venue database is provided that contains data for a plurality of venues. For each venue, the venue database includes past events that occurred at the venue for a predetermined past time period and the associated event date, a venue seating chart, event participant images captured at past events at a plurality of different seating locations, and data related to the event type for at least some of the past events.
2. The user searches the data in the venue database to identify a past event of interest.
3. A venue seating chart associated with the past event of interest is displayed.
4. The user selects a seating location on the seating chart.
5. One or more event participant images captured at the past event of interest at the selected seating location is displayed.
6. The user selects one or more of the images.
7. A plurality of different image editing functions are provided to a user on a user interface display screen.
8. The user applies one or more of the image editing functions to the one or more selected images via the user interface display screen.
9. One or more edited images are then printed.

No such multiple venue capabilities are disclosed in either U.S. Pat. No. 7,077,581 or U.S. Patent Application Publication No. 2003/0086123.
b. Store and recreate a plurality of different image editing functions applied to an image.

This embodiment includes at least the following steps:
1. An image database is provided that includes a plurality of images.
2. A user selects one or more of the images.
3. A plurality of different image editing functions are provided to the user on a user interface display screen.
4. The user applies one or more of the image editing functions to the one or more selected images via the user interface display screen.
5. An image database stores an identifier of each image that was edited, each of the different image editing functions applied to the one or more selected images, and the order of application of the different image editing functions.
6. Edited images are printed at a remote image printing location by using the identifier to retrieve an unedited version of the one or more selected images that were edited on the user interface display screen, and applying the same image editing functions to the one or more selected images as were applied via the user interface display screen in the same order of application.
7. A plurality of framing options are presented for the edited images.
c. Electronic imposing of a corporate logo border around the image.

This embodiment includes at least the following steps:
1. A remote image database is provided that includes a plurality of images. The remote image database is accessible via an electronic network.
2. A browser-based user interface display screen is provided at a user location that can request and retrieve selected images in the remote image database via the electronic network.
3. The user selects an image from the remote image database for display on the display screen.
4. A border, including a logo, is automatically and electronically imposed around the image. The border may be imposed in a non-removable manner.
5. The image is printed at an image printer. The printed image includes the border.
d. Selection of higher payment levels to print out images with no corporate logo borders or watermarks.

This embodiment includes at least the following steps:
1. A remote image database is provided that includes a plurality of images. The remote image database is accessible via an electronic network.
2. A browser-based user interface display screen is provided at a user location that can request and retrieve selected images in the remote image database via the electronic network.
3. The user selects an image from the remote image database for display on the display screen.
4. An image operation is provided that electronically imposes a non-removable border around the image. The image operation may be activated or deactivated.
5. An electronic payment process is established for allowing a user to pay for printing images via the electronic network. The electronic payment process includes a first option for printing images without the border around the image and a second option for printing images with the non-removable border around the image.
6. If the user selects the first option, the image operation is deactivated so that no non-removable border is imposed around the image. If the user selects the second option, the image operation is activated so that the non-removable border is imposed around the image.

A similar scheme is provided wherein the image operation is the imposition of a watermark on the image, wherein one option deactivates the imposition of the watermark on the image (i.e., no watermark is placed on the image), and another option activates the imposition of the watermark on the image (i.e., a watermark is placed on the image).
e. Automatic creation of collages (auto-collage).

This embodiment includes at least the following steps:
1. A remote image database is provided that includes a plurality of images. The remote image database is accessible via an electronic network. The images include event participants in attendance at an event venue. At least some of the images are associated with specific seating locations in the event venue.
2. A browser-based user interface display screen is provided at a user location that can request and retrieve selected images in the remote image database via the electronic network.
3. The user selects an image from the remote image database for display on the display screen. The selected image is associated with a specific seating location in the event venue.
4. The user selects a collage creation operation via the user interface.
5. One or more collages of images are automatically created for display on the display screen. Each collage includes the image selected by the user and at least one additional image associated with the same or adjacent seating location in the event venue as the user selected image. At least one of the images in each collage is an image that the user did not deliberately select.

Alternative embodiments of the collage process allows the user to include images of event participants.

II. Detailed Disclosure

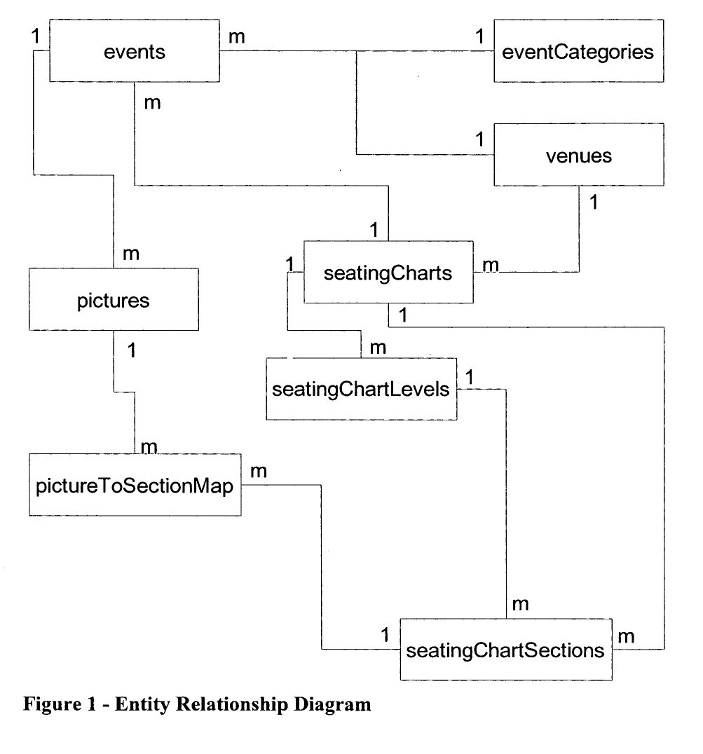

FIG. 1 is an entity relationship diagram describing the tables and their relationships that are used to store event related information. Foreign keys between the tables are represented by relationship lines drawn between each table. The labels “1” and “m” on either side of the relationship indicate that there is a one to many relationship, with many records on the “m” side for each unique record of the “1” associated table. The events table contains the representation of the individual events where pictures have been taken. Each events record is associated to a single eventCategories record by the eventCategoryId column in each table. The eventCategories table contains the classifications that describe each type of event. Each events record is also associated to a single venue record by the venueld column in each table. The venues table represents the physical location where a given event occurred. Each events record is also associated to a single seatingCharts record by the seatingChartId column in each table. The seatingCharts table represents the physical layout of the seating arrangement at a venue. Each venues record can be associated with many seatingCharts records through the venueId column in each table. Each events record is associated with multiple pictures records through the eventId column in each table. The pictures table represents information about each picture that is stored in the system. Each seatingCharts record is associated to many seatingChartLevels records and many seatingChartSections records through the seatingChartId column in each of the tables. The seatingChartLevels table represents the categories that are used to sub divide the layout of a seating chart. The seatingChartSections table represents the sub categories that are used to sub divide each level in a seating chart. Each record in the seatingChartSections table is associated with one record in the seatingChartLevels table. The pictureToSectionMap table represents the relationship between a pictures record and a seatingChartSections record. This relationship is between the pictureId column in the pictures and pictureToSectionMap tables and between the seatingChartSectionId column in the pictureToSectionMap and seatingChartSections tables.

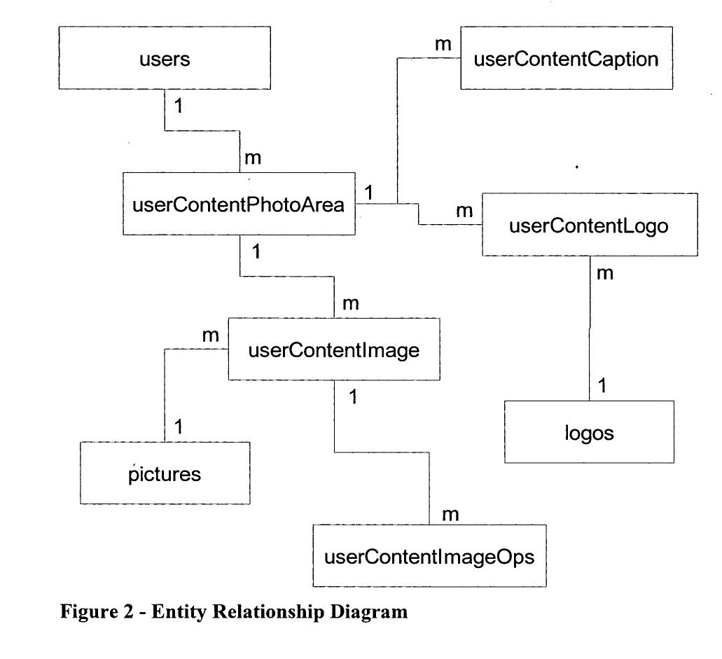

FIG. 2 is an entity relationship diagram describing the tables, and their relationships, that are used to store information about a user's saved pictures. Foreign keys between the tables are represented by relationship lines drawn between each table. The labels “1” and “m” on either side of the relationship indicate that there is a one to many relationship, with many records on the “m” side for each unique record of the “1” associated table. The users table contains a record for each of the registered users. Each users record is associated with multiple userContentPhotoArea records through the userId column in each table. The userContentPhotoArea table is the main table that holds information related to a user's image that can contain multiple captions, logos, and images. Each userContentPhotoArea record is associated with multiple userContentCaption records through the photoAreaId column in each table. The userContentCaption table represents the captions that have been added to a picture. Each userContentPhotoArea record is also associated with multiple userContentLogo records through the photoAreaId column in each of the tables. The userContentLogo table represents the logos that are embedded into a user's picture. Each userContentLogo record is associated with one logos record through the logoId column in each table. The logos table contains information about the logo files that are in the system. Each userContentPhotoArea record is associated with multiple userContentImage records through the photoAreaId column in each of the tables. The userContentImage table represents alterations made to the images in the system in order to produce a user's image. Each userContentImage record is associated with one record from the pictures table through the pictureId column in each table. The pictures table represents information about each picture that is stored in the system. Each userContentImage is also associated with multiple userContentImageOps records through the imageId column in each table. The userContentImageOps table represents operations that are performed on images in order to display the image in its final form.

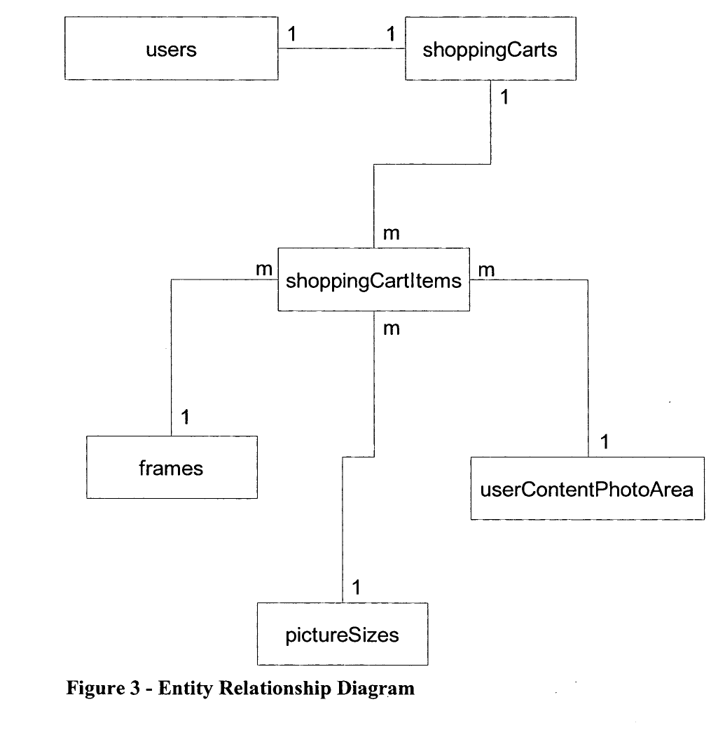

FIG. 3 is an entity relationship diagram describing the tables, and their relationships, that are used to store information about a user's shopping cart for purchasing pictures. Foreign keys between the tables are represented by relationship lines drawn between each table. The labels “1” and “m” on either side of the relationship indicate that there is a one to many relationship, with many records on the “m” side for each unique record of the “1” associated table. The users table contains a record for each of the registered users. Each users record is associated to one shoppingCarts record through the userId column in each of the tables. The shoppingCarts table contains a representation of the shopping cart that contains items a given user chooses to purchase. Each shoppingCarts record is associated with multiple shoppingCartItems records through the shoppingCartId column in each of the tables. The shoppingCartItems table contains information related to specific items in the user's shopping cart. Each shoppingCartItems record is associated with exactly one record in the frames table through the frameId column in each table. The frames table contains information about the framing options available for purchased pictures. Each shoppingCartItems record is also associated with one userContentPhotoArea record through the photoAreaId column in each table. Each shoppingCartItems record is also associated with one pictureSizes record through the pictureSizeId column in each table. The pictureSizes table contains information about the available picture sizes.

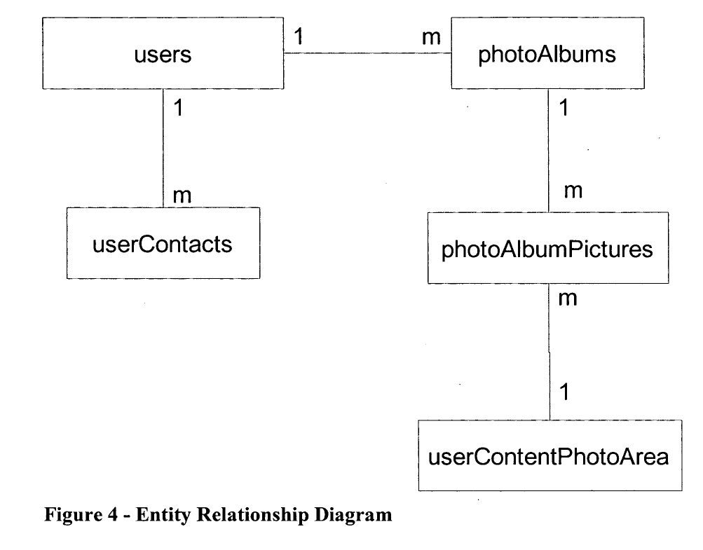

FIG. 4 is an entity relationship diagram describing the tables, and their relationships, that are used to store information about a user's stored pictures. Foreign keys between the tables are represented by relationship lines drawn between each table. The labels “1” and “m” on either side of the relationship indicate that there is a one to many relationship, with many records on the “m” side for each unique record of the “1” associated table. The users table contains a record for each registered user. Each users record is associated with multiple photoAlbums record through the userId column in each table. The photoAlbums table represents user entered categories used to organized a user's saved pictures. Each photoAlbums record is associated with multiple photoAlbumPictures records. The photoAlbumPictures table represents a relationship between a photoAlbums record and a userContentPhotoArea record. The photoAlbumPictures record is associated with one userContentPhotoArea record by the photoAreaId column in each table. Each users record is associated with many userContacts records through the userId column in each table. The userContacts table contains information about a people a user chooses to share photo albums with.

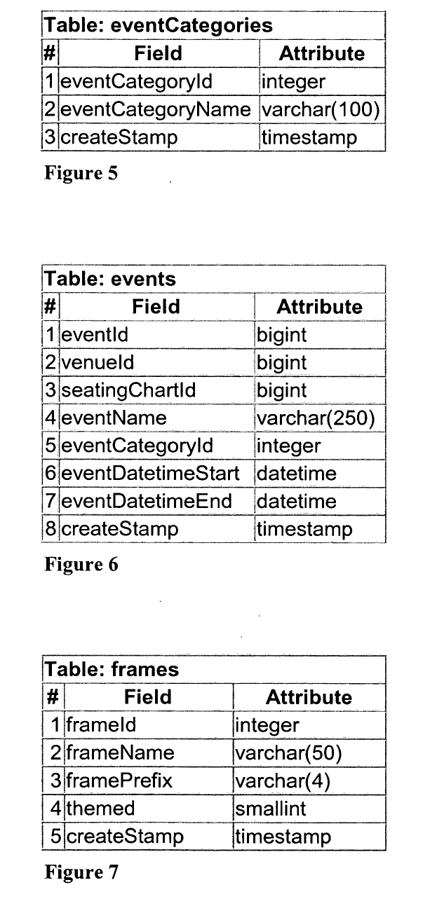

The eventCategories (FIG. 5) table contains the classifications that describe each event. The fields of eventCategories includes eventCategoryId, which is the primary key of the table and is an auto increment integer, eventCategoryName, which is the text string up to 100 characters wide the describes the category of the event, and createStamp, which is the date-timestamp when the record was created.

The events table (FIG. 6) contains the representation of the individual events where pictures have been recorded. The fields of events includes eventld, which is the primary key of the table and is an auto increment integer, venueld, which is a integer foreign key to the venueId column of the venues table, seatingChartId, which is an integer foreign key to the seatingChartId column of the seatingCharts table, eventName, which is a text string up to 250 characters wide containing a descriptive name of the event, eventCategoryId, which is an integer foreign key to the eventCategoryId of the eventCategories table, eventDatetimeStart, which is a date-timestamp indicating when the event started, eventDatetimeEnd, which is a date-timestamp indicating when the event ended, and createStamp which is the date-timestamp when the event record was created.

The frames table (FIG. 7) contains the representation of the available framing options for purchased pictures. The fields of the frames table includes frameId, which is the primary key of the table and is an auto increment integer, frameName, which is a text string up to 50 characters wide containing a descriptive name for the frame, framePrefix, which is a text string up to 4 characters wide containing the string to be prepended to the standard framing image file names for display in the user interface, themed, which is either a 0 or 1, representing whether the frame is a normal frame, or is themed for a particular event respectively, and createStamp which is the date-timestamp when the frame record was created.

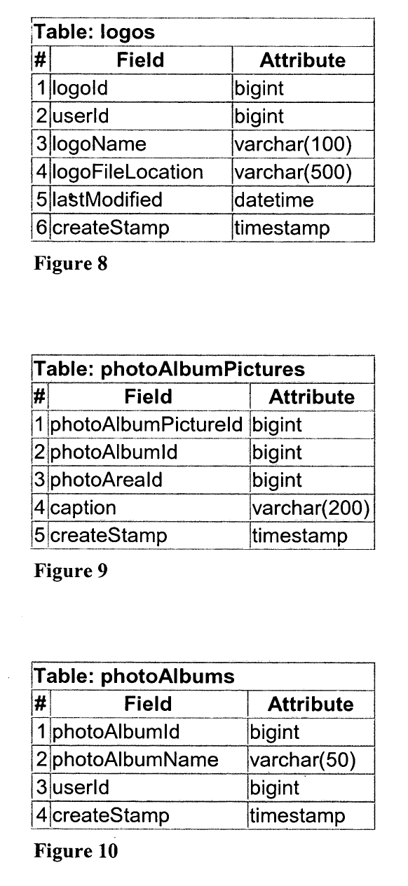

The logos table (FIG. 8) contains the information pertaining to the logos available in the system to be included in edited pictures. The fields of the logos table includes logoId, which is the primary key of the table and is an auto increment integer, userId, which is a foreign key to the userId column of the users table and represents the user that this logo belongs to, logoName, which is a text string up to 100 characters wide containing a descriptive name of the logo, logoFileLocation, which is a text string up to 500 characters long containing the physical logo file location on the server, lastModified, which is the date-timestamp containing the last time the logo was modified, and createStamp which is the date-timestamp when the logo record was created.

The photoAlbumPictures table (FIG. 9) represents the relationship between a user's saved pictures and a category name referred to as a photo album. The fields of the photoAlbumPictures table include photoAlbumPictureId, which is the primary key of the table and is an auto increment integer, photoAlbumId, which is a foreign key to the photoAlbumId column of the photoAlbums table and represents the photoAlbum this picture belongs to, photoAreaId, which is a foreign key to the photoAreaId column of the userContentPhotoArea table and represents the picture that is part of the photo album, caption, which is a text string up to 200 characters wide and contains a user entered caption describing the picture, and createStamp, which is a date-timestamp containg the date and time the record was added to the table.

The photoAlbums table (FIG. 10) represents the user entered categories for grouping their saved pictures. The fields of photoAlbums table include photoAlbumId, which is the primary key of the table and is an auto increment integer, photoAlbumName, which is a text string up to 50 characters wide containing the user entered name of the photo album, userId, which is a foreign key to the userId column of the users table and represents the user that this photo album belongs to, and createStamp which is the date-timestamp when the photo album record was created.

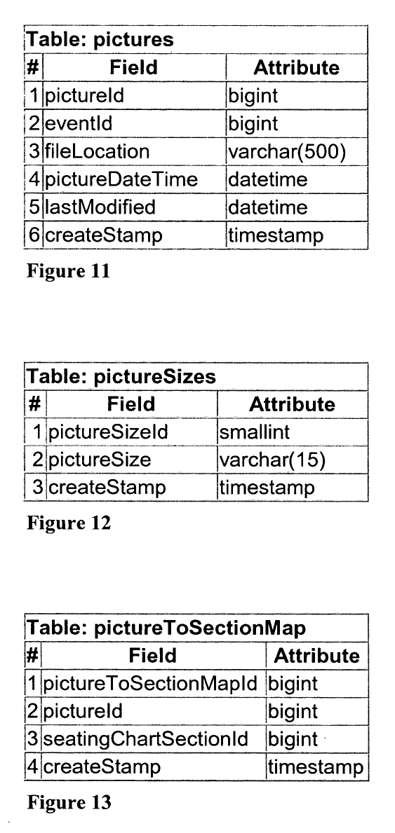

The pictures table (FIG. 11) represents information about each picture that is stored in the system. The fields of the pictures table includes pictureId, which is the primary key of the table and is an auto increment integer, eventId, which is a foreign key to the eventId column of the events table, fileLocation, which is a text string up to 500 characters wide that contains the physical image file location, lastModified, which is the date-timestamp when the picture record was last updated, and createStamp which is the date-timestamp when the picture record was created.

The pictureSizes table (FIG. 12) represents the available sizes of picture for purchase. The fields of the pictureSizes table includes pictureSizeId, which is the primary key of the table and is an integer, pictureSize, which is a text string up to 15 characters wide and represents the display name of the picture size record, and createStamp, which is the date-timestamp when the record was added.

The pictureToSectionMap table (FIG. 13) represents the relationship between a picture record in the pictures table and the physical location in terms of the seating chart that the picture was taken of. The fields of the pictureToSectionMap table include pictureToSectionMapId, which is the primary key of the table and is an auto increment integer, pictureId, which is a foreign key to the pictureId column of the pictures table and represents the picture that is being mapped, seatingChartSectionId, which is a foreign key to the seatingChartSectionId column of the seatingChartSections table and represents the seating chart section the that picture is mapped to, and createStamp, which is the date-timestamp when the record was added to the table.

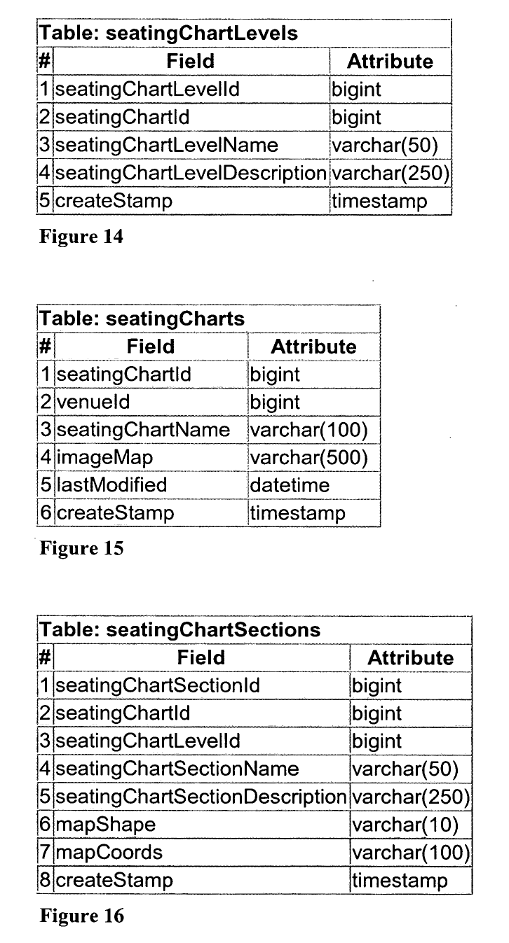

The seatingChartLevels table (FIG. 14) represents the physical levels that are used to categorize the layout of a venue through a seating chart. The fields of the seatingChartLevels table include seatingChartLevelId, which is the primary key of the table and is an auto increment integer, seatingChartId, which is a foreign key to the seatingChartId column of the seatingCharts table and represents the seating chart that this level belongs to, seatingChartLevelName, which is a text string up to 50 characters wide and represents the display name for the level, seatingChartLevelDescription, which is a text string up to 250 characters wide and represents the description of the level, and createStamp, which is the date-timestamp when the record was added to the table.

The seatingCharts table (FIG. 15) represents a physical layout of seating arrangements in a venue. The fields of the seatingCharts table include seatingChartId, which is the primary key of the table and an auto increment integer, venueId, which is a foreign key to the venueId column of the venues table, seatingChartName, which is a text string up to 100 characters wide the contains the name of the seating chart, imageMap, which is a text string up to 500 characters wide that contains the physical file location of the seating chart image, lastModified, which is the date-timestamp the seating chart was last modified, and createStamp, which is the date-timestamp when the record was added to the table.

The seatingChartSections table (FIG. 16) represents the physical sections that are used to organize the seating at a venue. The fields of the seatingChartSections table include seatingChartSectionId, which is the primary key of the table and an auto increment integer, seatingChartId, which is a foreign key to the seatingChartId column of the seatingCharts table and represents the seating chart that this section belongs to, seatingChartLevelId, which is a foreign key to the seatingChartLevelId column of the seatingChartLevels table and represents the seating chart level that this section belongs to, seatingChartSectionName, which is a text string up to 50 characters wide that contains the name of the section, seatingChartSectionDescription, which is a text string up to 250 characters wide that contains a description of the section, mapShape, which is a text string up to 10 characters wide and is used to denot e the shape of the section in the html image map used to navigate through the seating chart, mapCoords, which is a text string up to 100 characters wide and is used to hold a comma separated list of coordinates indicating the boundries of the html image map section, and createStamp, which is the date-timestamp when the record was added to the table.

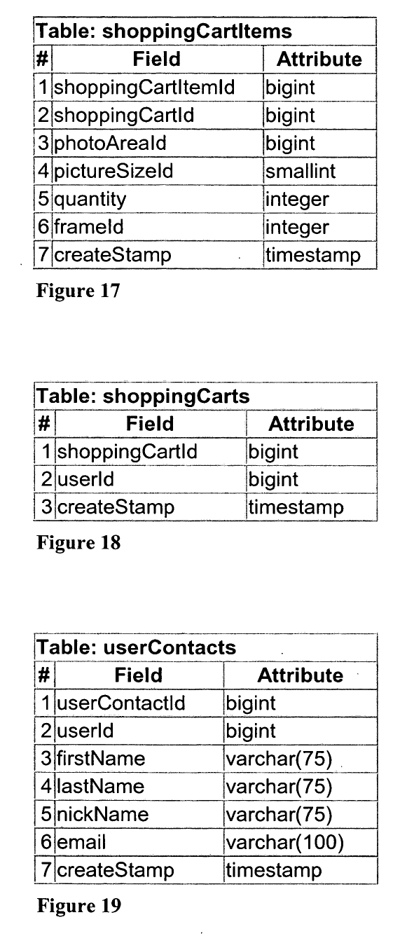

The shoppingCartItems table (FIG. 17) contains information related to pictures that the user intends to purchase. The fields of the shoppingCartItems table include shoppingCartItemId, which is the primary key of the table and is an auto increment integer, shoppingCartId, which is a foreign key to the shoppingCartId column of the shoppingCarts table and indicates the shopping cart that contains these items, photoAreaId, which is a foreign key to the photoAreaId column of the userContentPhotoArea table and indicates the picture that will be bought, pictureSizeId, which is a foreign key to the pictureSizeId column of the pictureSizes table and indicates the size of the picture to be purchased, quantity, which is a integer indicating the number of items to be purchased, frameId, which is a foreign key to the frameId column of the frames table and indicates the type of frame to be purchased, and createStamp, which is the date-timestamp when the record was created.

The shoppingCarts table (FIG. 18) contains a representation of the shopping cart that contains items a given user chooses to purchase. The fields of shoppingCarts include shoppingCartId, which is the primary key of the table and is an auto increment integer, userId, which is a foreign key to the users table and represents the user that this shopping cart belongs to, and createStamp, which is the date-time stamp when the shopping cart record was created.

The userContacts table (FIG. 19) contains an address book of contact information for friends that the user's content will be shared with. The fields of the userContacts table include userContactId, which is the primary key of the table and is an auto increment integer, userId, which is a foreign key to the userId column of the users table and indicates the user that owns this user contact entry, firstName, which is a text string up to 75 characters wide and contains the first name of the contact, lastName, which is a text string up to 75 characters wide and contains the last name of the contact, nickName, which is a text string up to 75 characters wide and contains the nick name of the contact, email, which is a text string up to 100 characters wide and contains the email address of the contact, and createStamp, which is the date-timestamp when the record was created.

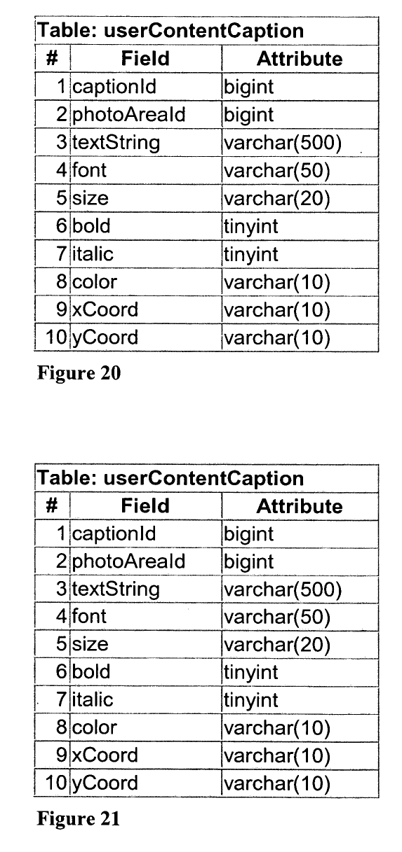

The userContentCaption table (FIG. 20) represents the captions that have been added to a picture. The fields of the userContentCaption table include captionId, which is the primary key of the table and an auto increment integer, photoAreaId, which is a foreign key to the photoAreaId table indicating the picture that the caption is on, textString, which is a text string up to 500 characters wide that contains the words that make up the caption, font, which is a text string up to 50 characters wide that contains the font that the caption is displayed in, size, which is a text string up to 20 characters wide that indicates the size of the caption, bold, which is either 0 or 1 and indicates whether the caption should be normal or bold, italic, which is either 0 or 1 and indicates whether the caption should be normal or italic, color, which is a text string up to 10 characters wide that contains the color of the caption, xCoord, which is a text string up to 10 characters wide that contains the horizontal position of the caption on the picture, yCoord, which is a text string up to 10 characters wide that contains the vertical position of the caption on the picture.

The userContentImage table (FIG. 21) represents the images that have been combined into a single picture. The fields of the userContentImage table include imageId, which is the primary key of the table and an auto increment integer, photoAreaId, which is a foreign key to the photoAreaId column of the userContentPhotoArea table and indicate the combined picture this image belongs to, pictureId, which is a foreign key to the pictureld column of the pictures table and indicates the actual picture that will be operated on, blackAndWhite, which is either 0 or 1 indicating whether the picture is in color or not, xCoord, which is a text string up to 10 characters wide and indicates the horizontal position of the image on the canvas, yCoord, which is a text string up to 10 characters wide and indicates the vertical position of the image on the canvas, outerX, which is an integer that contains an offset used for horizontal positioning, outerY, which is an integer that contains an offset used for vertical positioning, height, which is an integer indicating the height of the image, and width, which is an integer indicating the width of the image.

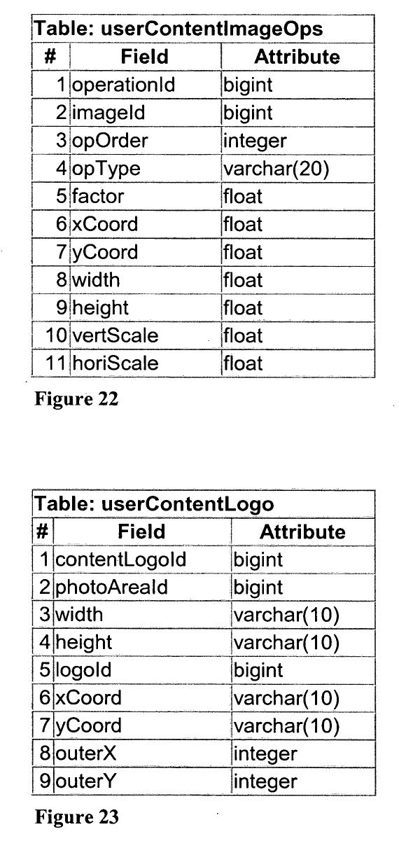

The userContentImageOps table (FIG. 22) represents operations that are performed on images from the userContentImage table in order to display the image in its final form. The fields of the userContentImageOps table include operationId, which is the primary key of the table and is an auto increment integer, imageId, which is a foreign key to the imageId column of the userContentImage table and indicates the image that this operation is performed on, opOrder, which is an integer representing the order in which this operation is performed, opType, which is a text string up to 20 characters wide and indicates the type of operation, factor, which is a float and is used to hold the factor parameter if applicable for the operation, xCoord, which is a float and is used to hold the x coordinate for the operation, yCoord, which is a float and is used to hold the y coordinate for the operation, width, which is a float and is used to hold the width parameter for the operation if applicable, height, which is a float and is used to hold the height parameter for the operation if applicable, vertScale, which is a float and is used to hold the vertical scaling factor if applicable for the operation, and horiScale, which is a float and is used to hold the horizontal scaling factor if applicable for the operation.

The userContentLogo table (FIG. 23) represents logos that are included in user's saved images. The fields of the userContentLogo table include contentLogoId, which is the primary key of the table and is an auto increment integer, photoAreaId, which is a foreign key to the photoAreaId column of userContentPhotoArea table and indicates the photo area that this logo is included in, width, which is a text string up to 10 characters wide and contains the width of the logo, height, which is a text string up to 10 characters wide and contains the height of the logo, logoId, which is a foreign key to the logoId column of the logos table and indicates the logo that will be displayed, xCoord, which is a text string up to 10 characters wide and indicates the horizontal position of the logo, yCoord, which is a text string up to 10 characters wide and indicates the vertical position of the logo, outerX, which is an integer and is used to hold an offset value for the horizontal position, and outerY, which is an integer and is used to hold an offset value for the vertical position.

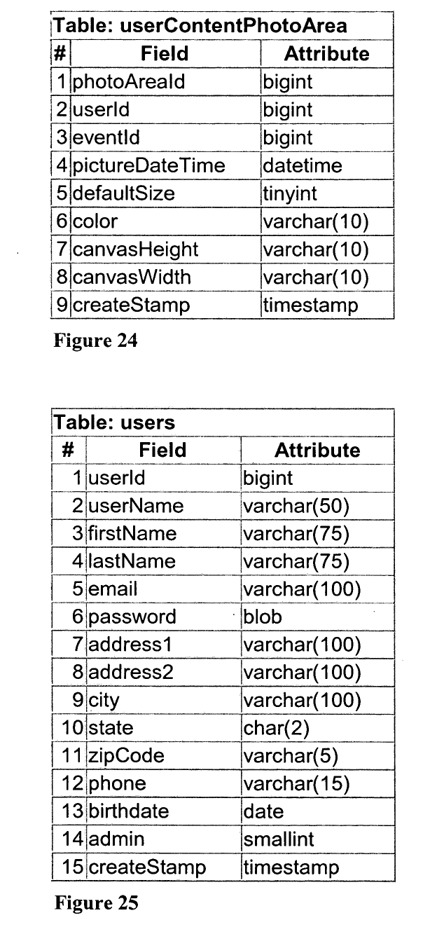

The userContentPhotoArea table (FIG. 24) is the main table that holds information related to a user specific image that can contain multiple captions, logos, and images. The fields of userContentPhotoArea include photoAreaId, which is the primary key of the table and is an auto increment integer, userId, which is a foreign key to the userId column of the users table and indicates the user that this photo area belongs to, eventId, which is a foreign key to the eventId column of the events table and indicates the event that the main picture in this photo area was taken at, pictureDateTime, which is the date-timestamp when the main picture was taken, defaultSize, which is either 0 or 1 indicating whether the canvas that the images are on is bigger than the size of the main image, color, which is a text string up to 10 characters wide and indicates the color of the canvas the images are on, canvasHeight, which is a text string up to 10 characters wide and indicates the height of the canvas, canvasWidth, which is a text string up to 10 characters wide and indicates the width of the canvas, and createStamp, which is the date-timestamp when the record was added to the table.

The users table (FIG. 25) represents the registered users of the website. The fields of the users table include userId, which is the primary key of the table and is an auto increment integer, userName, which is a text string up to 50 characters wide and contains the user's login name, firstName, which is a text string up to 75 characters wide and contains the first name of the user, lastName, which is a text string up to 75 characters wide and contains the last name of the user, email, which is a text string up to 100 characters wide and contains the email address of the user, password, which is a blob field and contains the user's login password, address1, which is a text string up to 100 characters wide and contains the user's first address line, address2, which is a text string up to 100 characters wide and contains the second line of the user's address, city, which is a text string up to 100 characters wide and contains the city of the user's address, state which is a text string up to 2 characters wide and contains the state of the user's address, zipCode, which is a text string up to 5 characters wide and contains the postal code of the user's address, phone, which is a text string up to 15 characters wide and contains the user's phone number, birthdate, which is a date field containing the user's date of birth, admin, which is a integer field that contains a flag indicating whether the user is an admin user or not, and createStamp, which is the date-timestamp of when the record was added to the table.

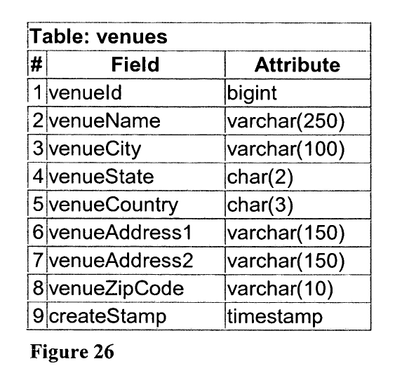

The venues table (FIG. 26) represents the physical location where a given event occurred. The fields of the venus table include venueld, which is the primary key of the table and is an auto increment integer, venueName, which is a text string up to 250 characters in length and represents the name of the venue, venueCity, which is a text string up to 100 characters in length and represents the city where the venue is located, venueState, which is a text string up to 2 characters wide and represents the state where the venue is located, venueCountry, which is a text string up to 3 characters wide and represents the country where the venue is located, venueAddress1, which is a text string up to 150 characters wide and represents the primary address where the venue is located, venueAddress2, which is a text string up to 150 characters wide and represents the secondary address where the venue is located, venueZipCode, which is a text string up to 10 characters wide and represents the postal code where the venue is located, and createStamp which is the date-timestamp when the venue record was added.

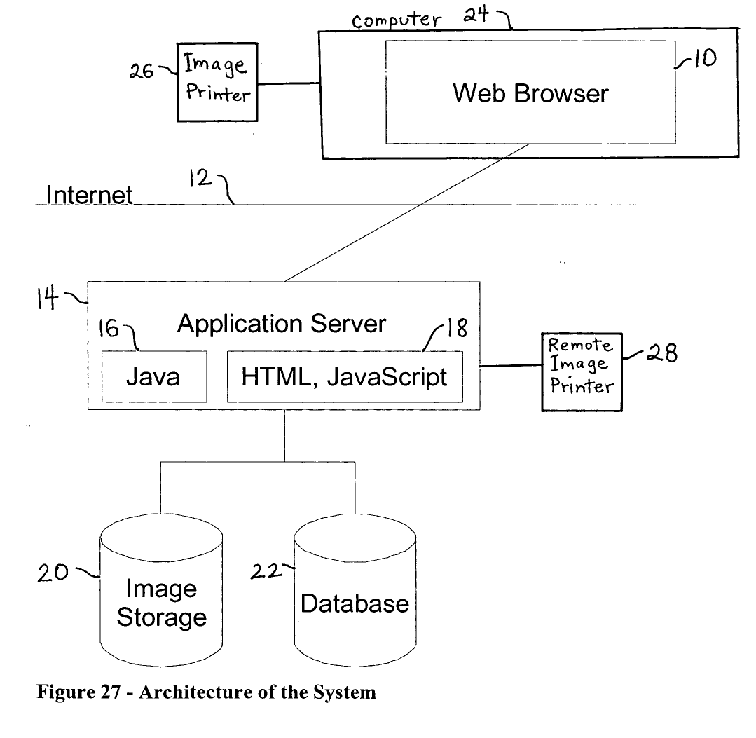

FIG. 27 shows the overall architecture of one preferred embodiment of the system. The system includes a web browser 10 connected via an electronic network (e.g., the Internet 12) to an application server 14. The application server 14 includes Java 16 and HTML and JavaScript 18. The application server 14 is interconnected to image storage 20 and a database 22. In one preferred embodiment, the web browser 10 is associated with a computer 24, such as a personal computer, having a local image printer 26. The application server 14 may also be directly or indirectly connected to a remote image printer 28 for printing images ordered by users.

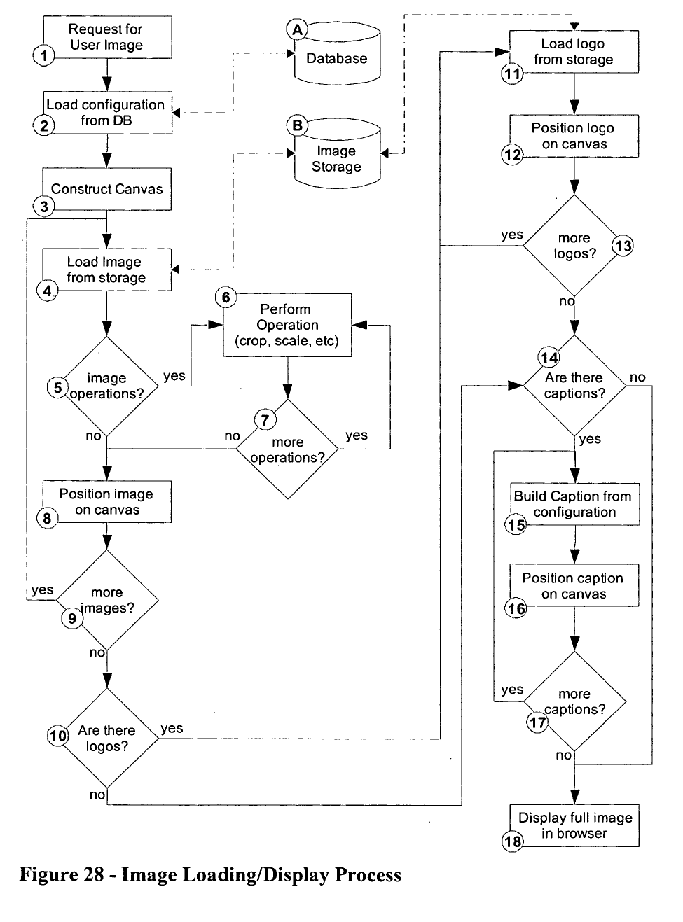

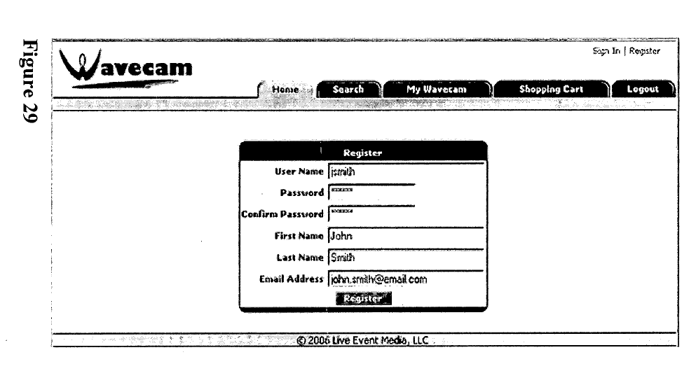

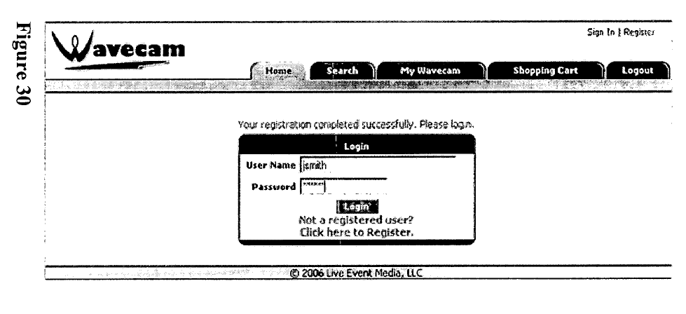

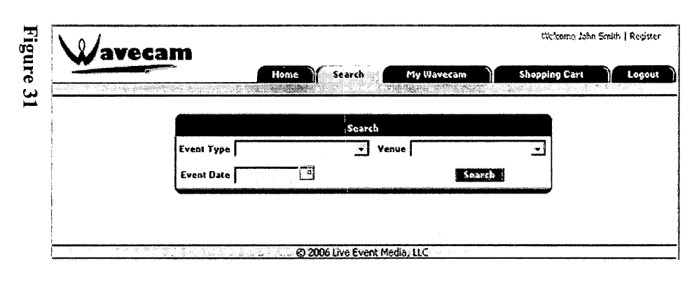

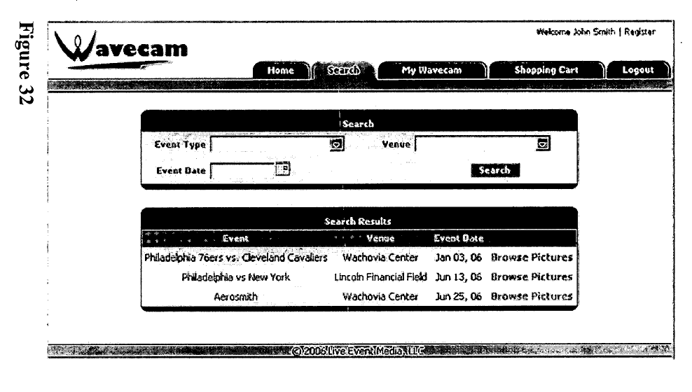

FIG. 28 details the process of loading and displaying a user's customized image. The process starts in step 1 with a user's request to display an image. All the information needed to reconstruct a user's customized image is stored in the database (A). In step 2, this information is loaded from the database. The configuration is first used to construct the image's canvas, which is the area that the user's customized image is placed on. The canvas has a height, width, and color. The color of the canvas is only important if there are any areas not covered by images or logos. In step 4, the sub-images that make up the final customized image are loaded. There can be multiple sub-images per customized image. The first image is loaded using the file location that is part of the configuration that was loaded in step 2. The image is loaded from the image storage (B) that is either a file system or database. After the image is loaded, we check to see if there are any image operations, step 5, that need to be performed on the image. If there are no image operations, steps 6 and 7 are skipped and step 8 is performed. If there are image operations, they are performed in step 6. Image operations will affect the appearance of the sub-image by cropping its size, scaling it to a smaller or larger size, and by changing the brightness, sharpness, and/or color of the sub-image. There can be multiple image operations per sub-image, so step 7 is used to loop over step 6 until all operations have been performed.

The operations in step 6 are performed using the Java Advanced Imaging API. At least the following operations can be performed:
1. Cropping—cropping an image is performed using the CropDescriptor of the Java Advanced Imaging API.
2. Brightening—brightening an image is performed using the AddConstDescriptor of the Java Advanced Imaging API.
3. Scaling—scaling an image is performed using the ScaleDescriptor of the Java Advanced Imaging API.
4. Sharpening—sharpening an image is performed using the UnsharpMaskDescriptor of the Java Advanced Imaging API.
5. Black and White—to make an image black and white, the BandCombineDescriptor of the Java Advanced Imaging API is used.
6. Watermarking—embedding a watermark in an image is accomplished by using a combination of the NotDescriptor and the SubtractDescriptor of the Java Advanced Imaging API.

The Java Advanced Imaging API source code is commercially available from Sun Microsystems, Inc. and can be downloaded at:

http://java.sun.com/products/java-media/jai/current.html.

Documentation for each of the above-described functions is also available at:

http://java.sun.com/products/java-media/jai/docs/index.html.

Once all operations are performed, the sub-image is positioned on the canvas in step 8 using coordinates that were loaded in the configuration. Since there can be more than one sub-image, step 9 is used to loop back to step 4 until all sub-images are loaded. Once the loading of sub-images is complete, the process moves on to step 10.

Step 10 checks to see if there are any logos associated with this customized image. Each customized image can have multiple logos, which are smaller images like a corporate logo or sporting team logo. If there are no logos for this customized image, the process moves to step 14, otherwise the first logo is loaded in step 11. Step 11 loads the logo using the file location loaded in the configuration. The logo is loaded from the image storage (B). Once the logo is loaded, it is positioned and sized on the canvas using the configuration information in step 12. Step 13 is used to loop back to step 11 until all the logos are loaded and positioned. Once they are, the process moves to step 14.

Step 14 checks to see if there are any captions associated with this customized image. Each customized image can have multiple captions, which are user entered text strings that have customizable font, size, color, position, and can be bold and italicized. If there are captions, step 15 is used to build those captions with the configuration loaded in step 2 and then step 16 is used to position the captions on the canvas. Step 17 is used to loop back to step 15 until all the captions are loaded and positioned. Once they are all positioned, the process moves to step 18 and displays the final customized image to the user.

When the user enters the site (FIG. 29), they will need to first register using a user name, password, their first and last name, and an email address.

Registered users will then log in (FIG. 30) to the site using their user name and password.

The screen user's will first visit (FIG. 31) is the main search screen. This screen will allow the user to search for events where pictures have been taken. This screen will allow the user to narrow their search results using an event type filter, a venue filter, and an event date. The event type describes the category that the even falls into, for example a baseball game or a football game or a concert. The venue describes the physical location where the event took place, for example a stadium, arena, or concert hall. The event date will filter the events using the event start date and end date associated with each event.

The search results screen (FIG. 32) displays all events that fit the criteria in the search filters. A row will be display for each event listing the event name, the venue and the date of the event. The user will be able to browse the pictures associated with each event by clicking on the “Browse Pictures” link next to each event..

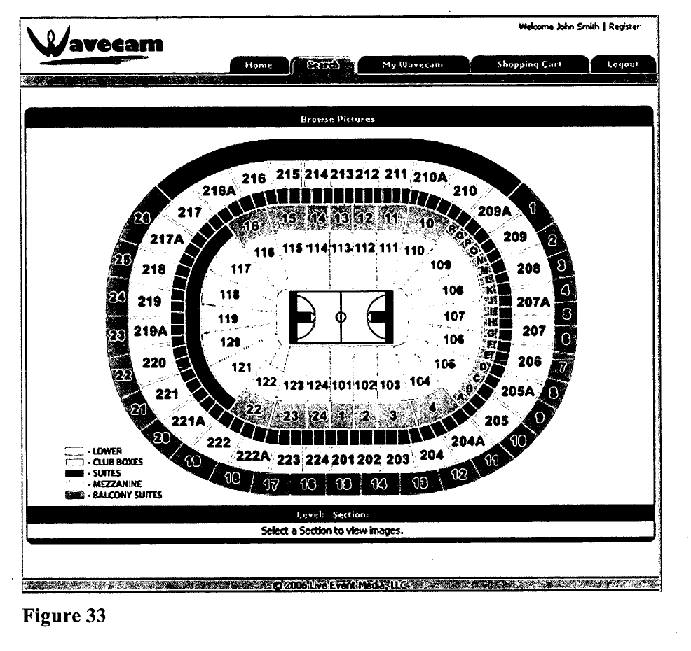

The browse pictures screen (FIG. 33) will display a graphic of the seating chart associated with the venue for the chosen event. The user can click on a seating chart section in order to see the pictures that were taken of that section.

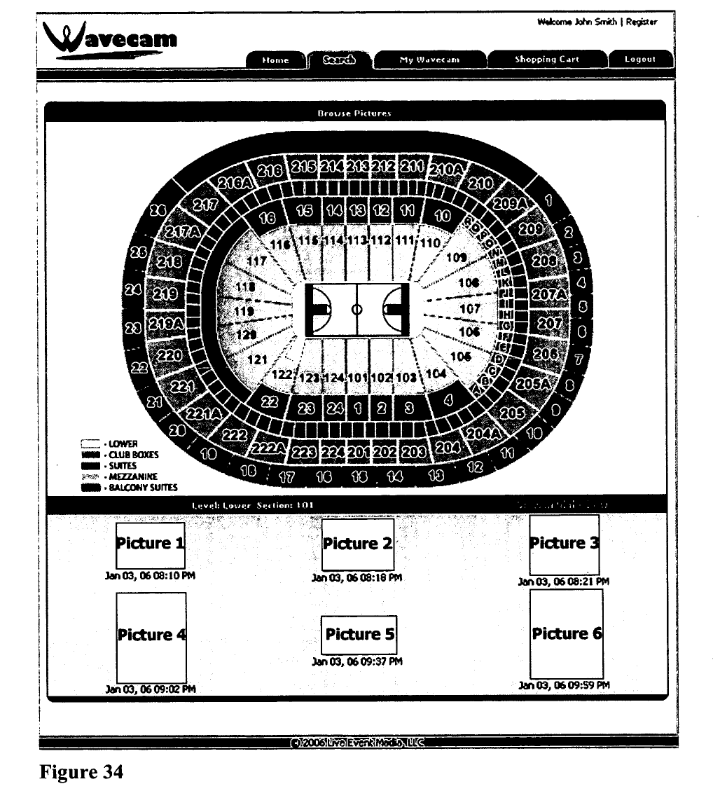

After clicking on a seating chart section, the user will see (FIG. 34) all the pictures taken of that section for the event. The user can see a single picture in the image editing screen by clicking on a single image or can view a slideshow of all pictures by clicking on the “View in Slideshow” link. For clarity, FIG. 34 depicts the thumbnail pictures with plain white rectangles labeled with a picture number. This convention is followed in all figures containing images.

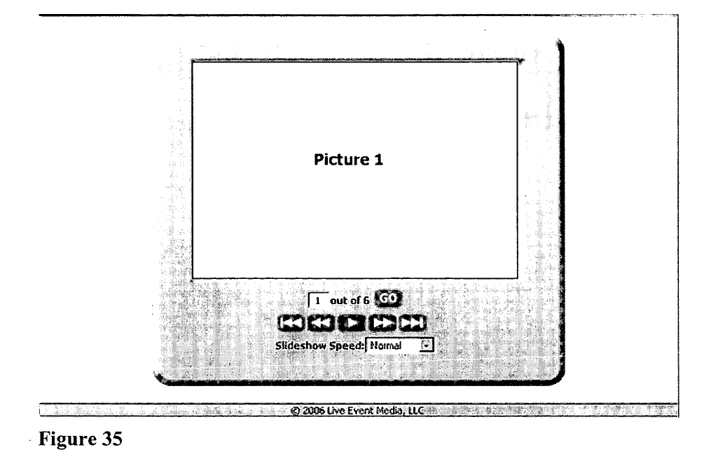

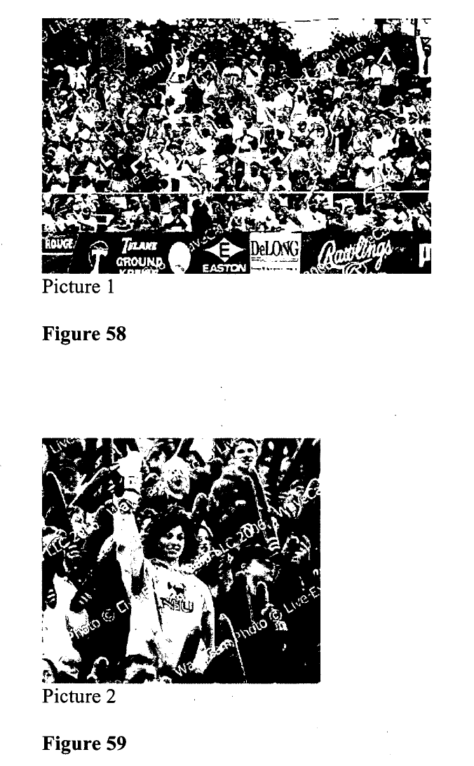

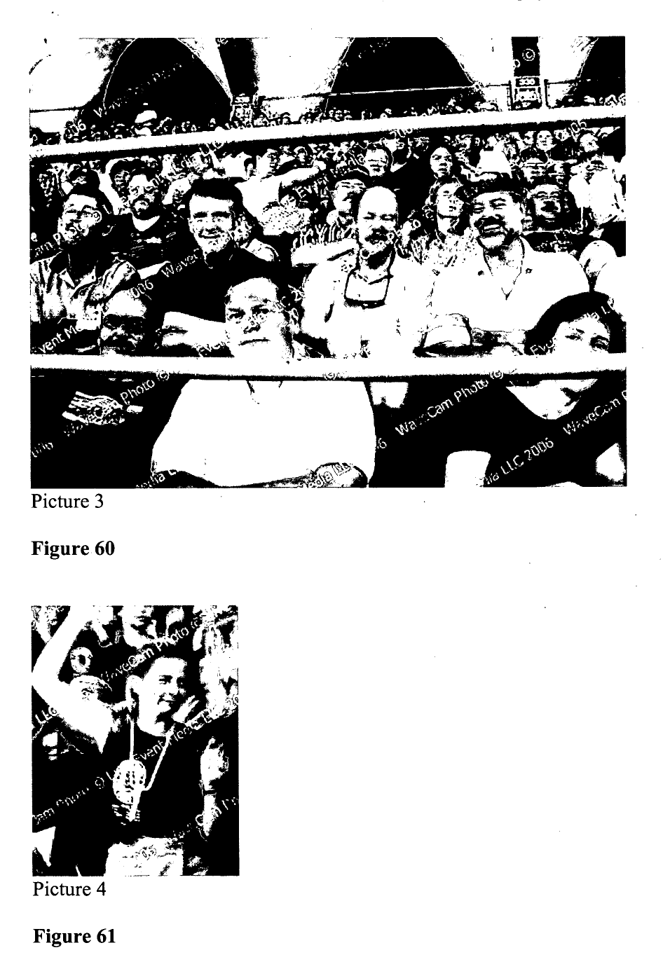

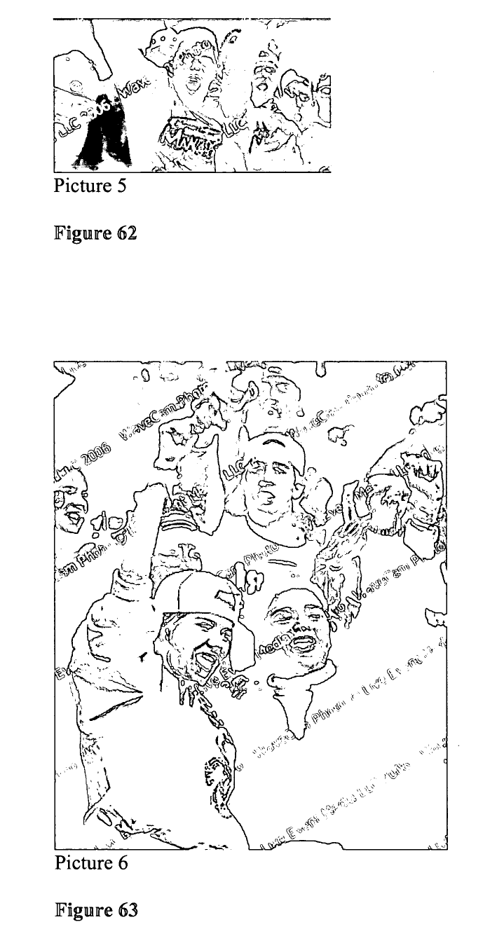

The slideshow screen (FIG. 35) will cycle through all the selected pictures. The user can jump to any picture and adjust the speed of the slideshow. (To simplify illustration of the pictures, the screen displays merely refer to pictures by numbers 1-6. Sample pictures 1-6 are shown in FIGS. 58-63.

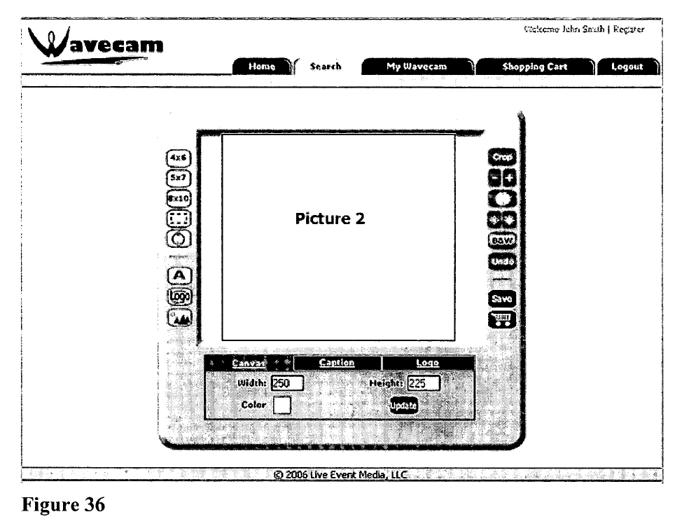

The image editing screen (FIG. 36) provides the user with numerous image editing functions. The user can crop, scale, brighten, sharpen, and make the image black and white. To crop and scale, the user is given several templates that are in standard picture size ratios, like 4×6 and 8×10, and a free form template; all of which can be rotated. The user can insert captions, logos, and other images onto the canvas. The user can also edit attributes of the canvas, captions, and logos.

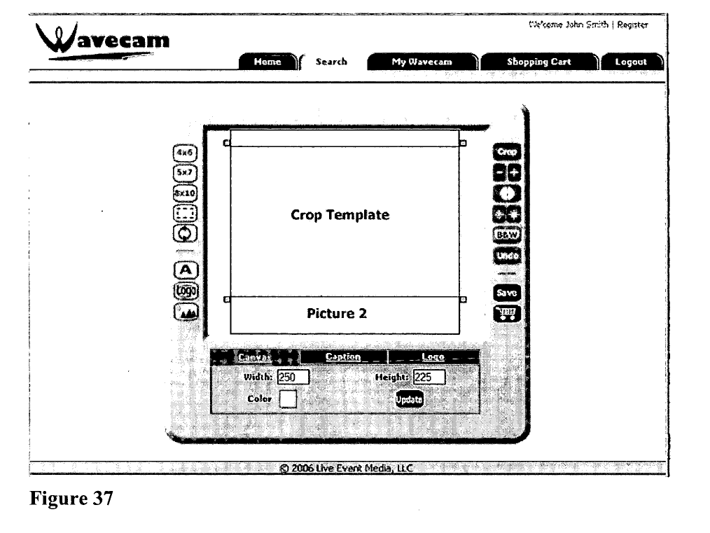

FIG. 37 shows the 4×6 template that can be positioned anywhere over the image.

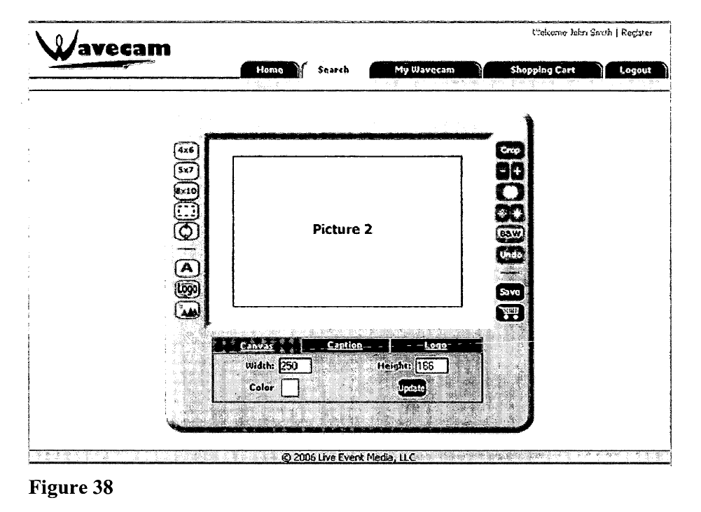

With the 4×6 template positioned over the use, the crop button is clicked and the resultant image shows only the portion of the picture that was under the template (FIG. 38). An undo button is available to reverse any changes made.

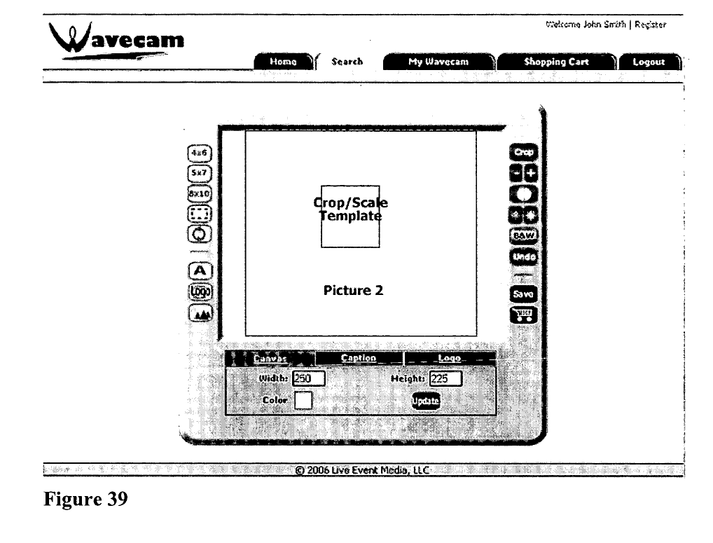

The template is now shrunk (FIG. 39) and positioned over a smaller portion of the image. The corners of the template can be used to resize the template.

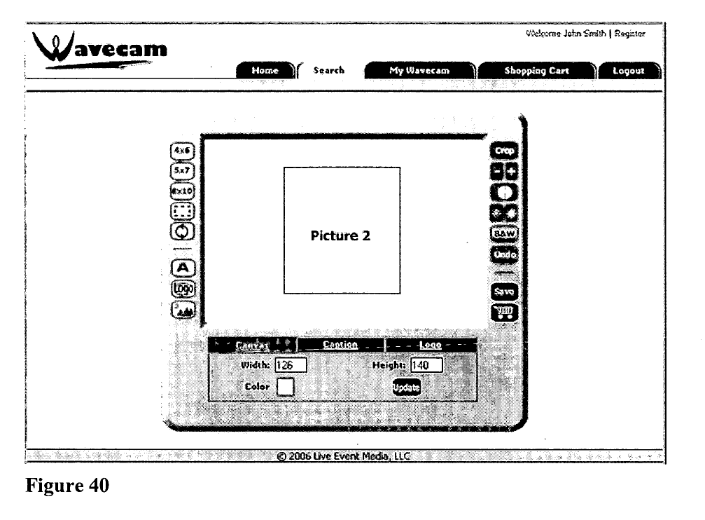

The zoom in scaling function is clicked (FIG. 40) and the small area from FIG. 39 is cropped and then zoomed to increase its size.

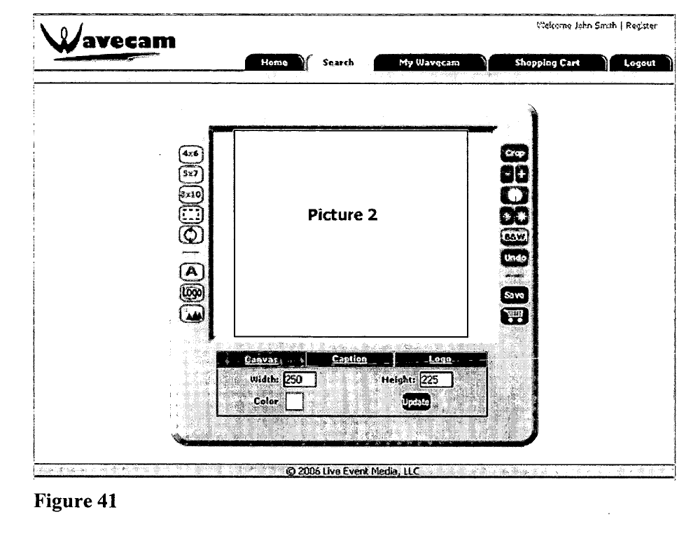

The user can make the image black and white using the B&W function (FIG. 41).

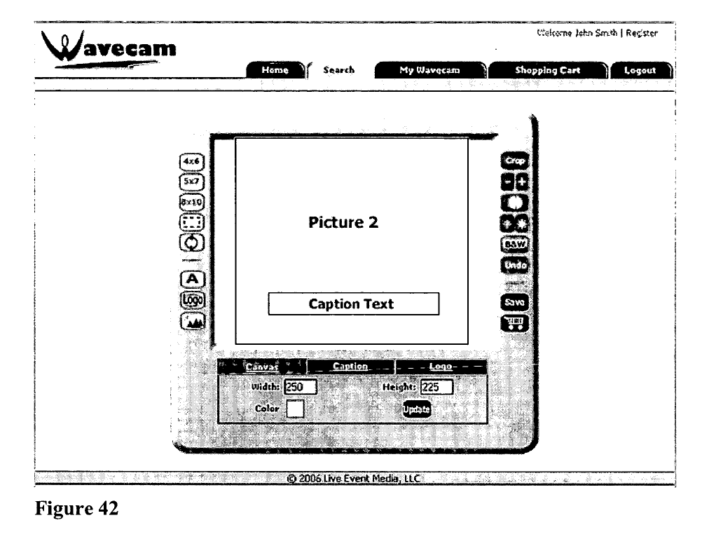

The user can insert a caption onto the canvas (FIG. 42). The caption's text, font, size, and color can be altered. The user can also make the caption bold or italic. The user can also delete any caption that is no longer wanted.

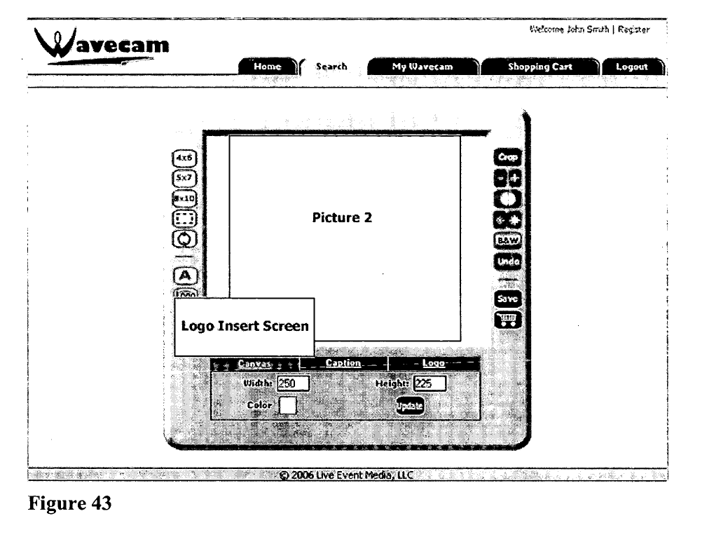

The user can also insert a logo onto the canvas (FIG. 43).

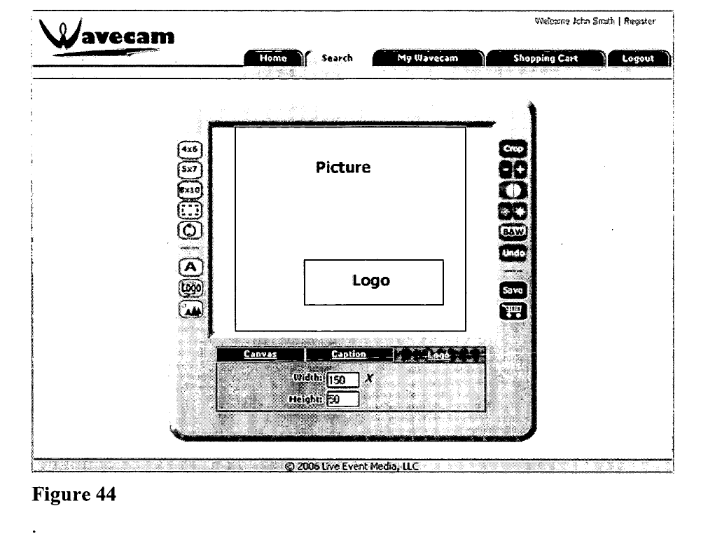

he logo can be positioned anywhere on the canvas by the user (FIG. 44). The width and height of the logo can be adjusted.

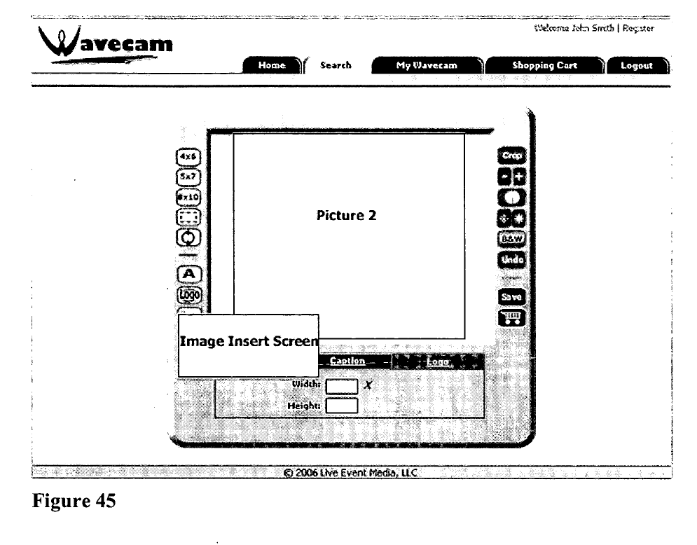

The user can insert other pictures onto the canvas (FIG. 45).

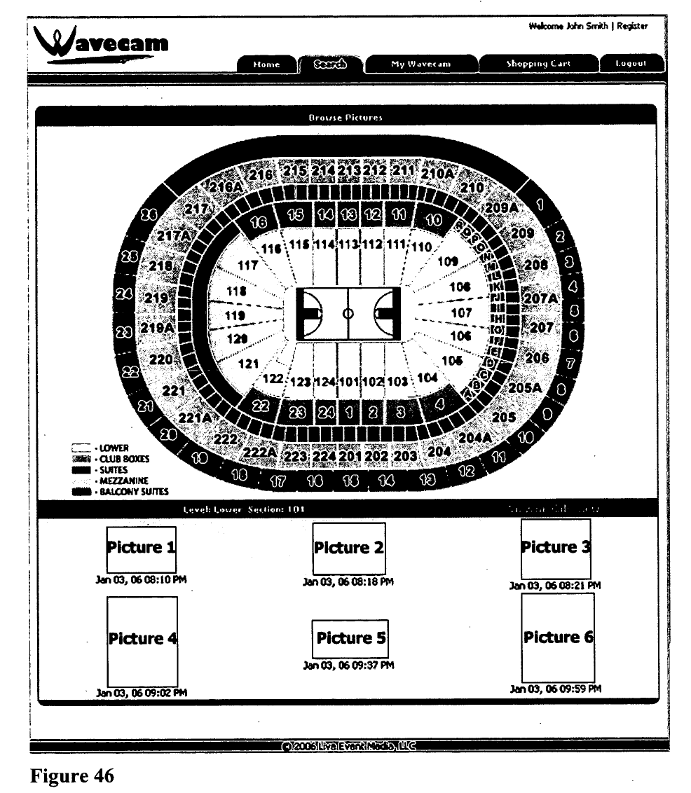

The user can search (FIG. 46) for the image to insert through the standard search screens. The user selects an image to insert by clicking on it.

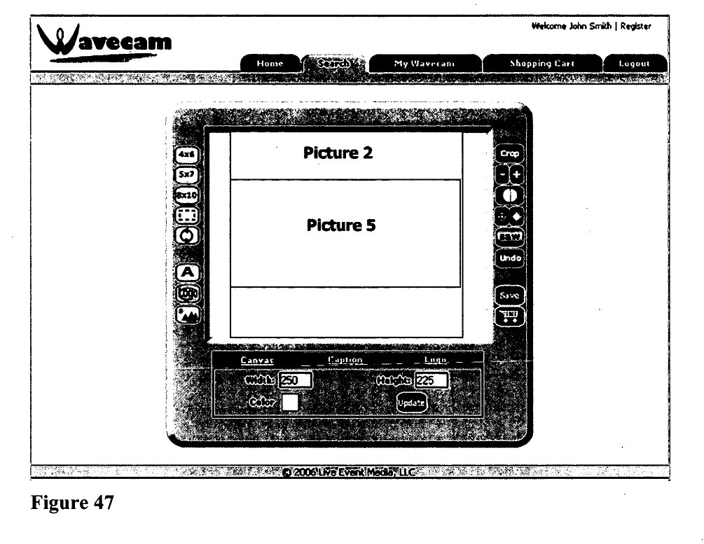

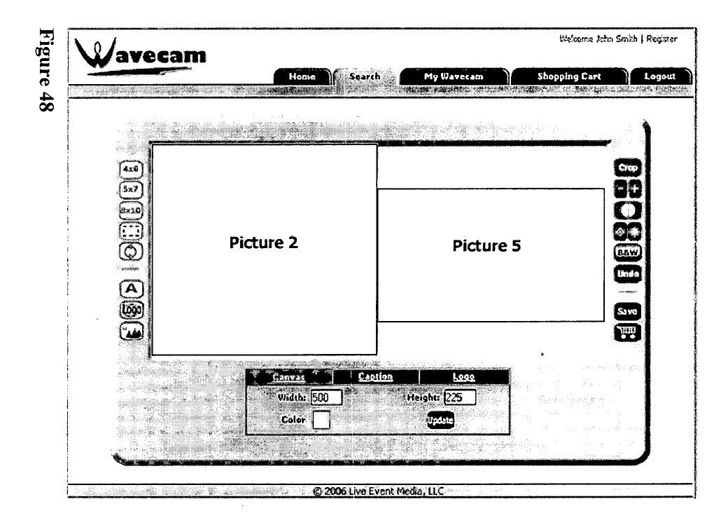

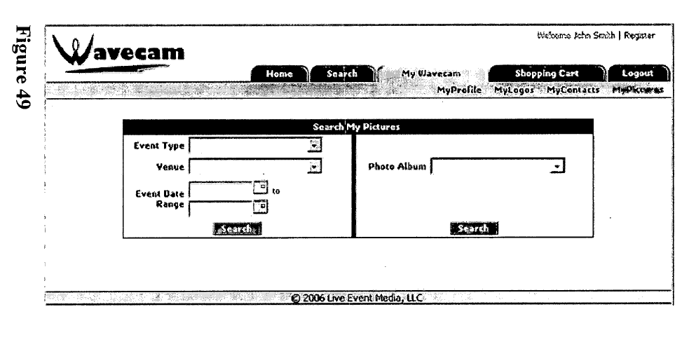

The user can position the image on the canvas (FIG. 47).

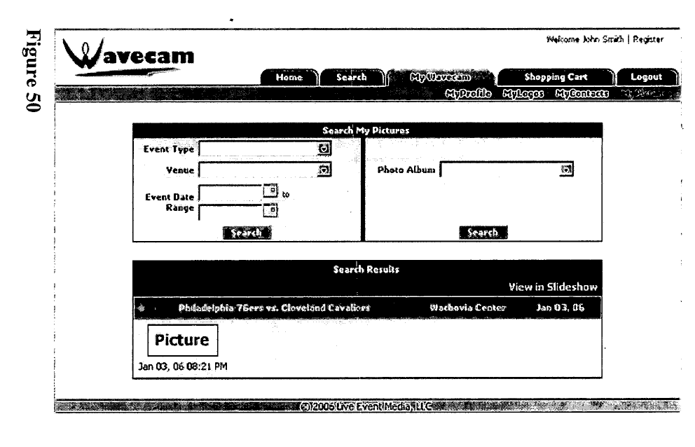

The user can adjust the size of the canvas and can change the color of the canvas background (FIG. 48). The user can save the picture to their “My Wavecam” section or add the picture to their shopping cart. When saving the picture to their “My Wavecam” section, they have the opportunity to save the picture to a specific photo album.

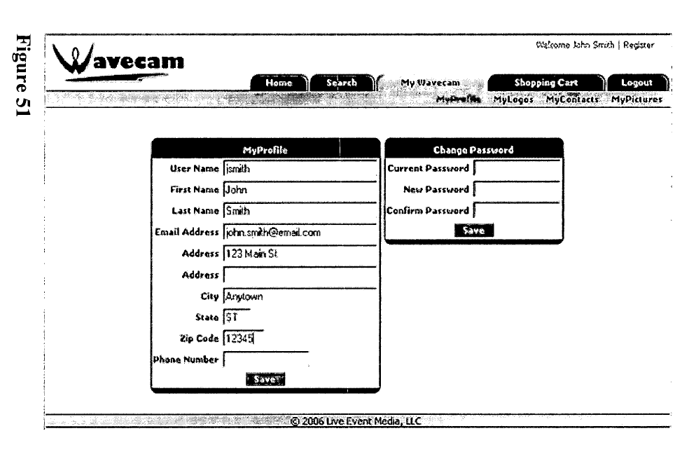

The MyPictures section (FIG. 49) allows the user to search through the pictures that the user saved. The user can search by event type, venue, event date ranger, or by photo album name.

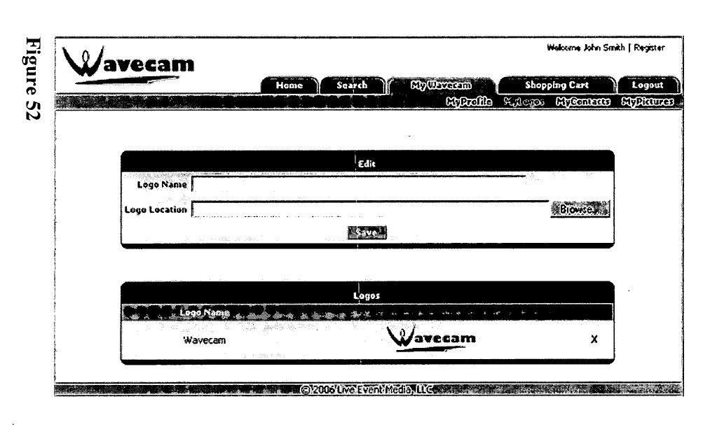

The search results (FIG. 50) will display each saved picture. The user can view all the search results in a slideshow using the View in Slideshow link.

Each user has a private section of the site called “My Wavecam” (FIG. 51). This section includes profile and contacts pages. The profiles section allows the user to update personal information like their address, email, phone number, and update their password.

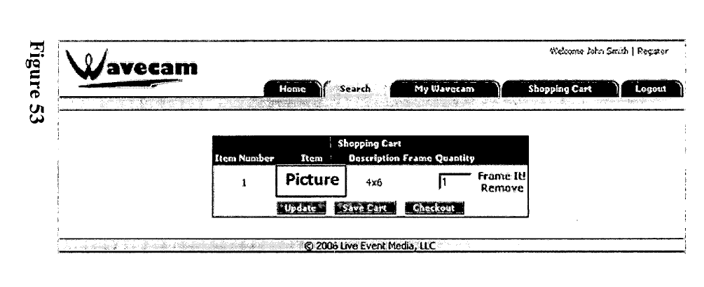

The MyWavecam section also includes a section that allows the user to upload their own logos to include in their customized pictures (FIG. 52).

The shopping cart shows a summary (FIG. 53) of the pictures that the user chooses to purchase. Each item in the shopping cart will show a thumbnail of the picture, the size of the picture being purchased, the quantity, and any framing options. Clicking on the “Frame It!” link navigates the user to the framing options page.

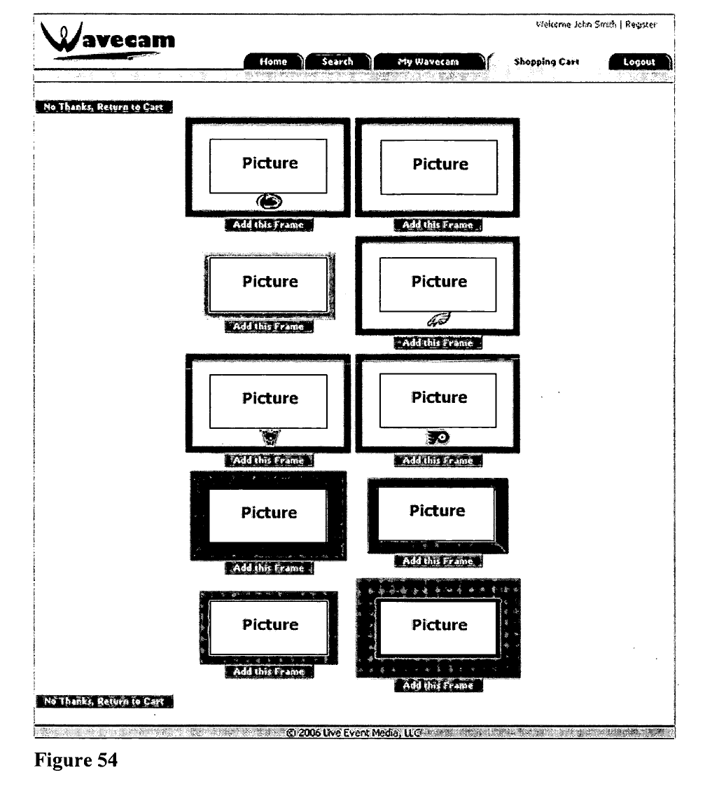

The framing options page shows the user's customized image (FIG. 54) in each of the frames available in the system. When the user decides upon a frame, they can add the frame to the shopping cart.

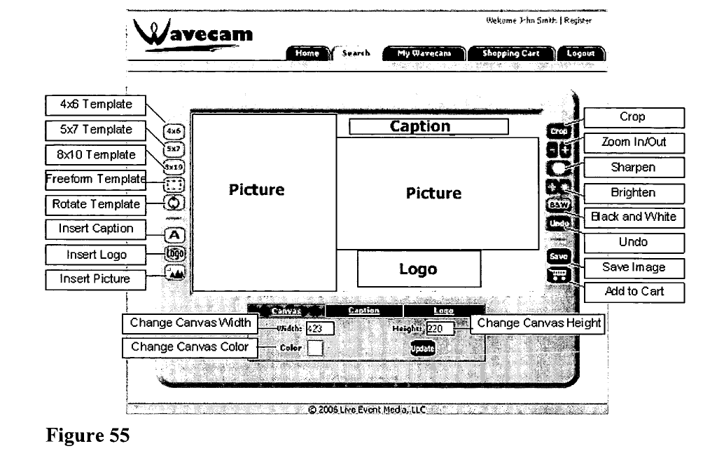

FIG. 55 shows a customized user image that uses most of the functionality of the image editor. The picture on the left was the initial picture. It was first cropped, and then changed to black and white. After that, it was made brighter and sharper. The picture on the left was inserted into this customized image. The canvas size was increased to accommodate this picture. The canvas color was also changed. The caption in the upper right hand corner was added along with the logo on the bottom right hand side.

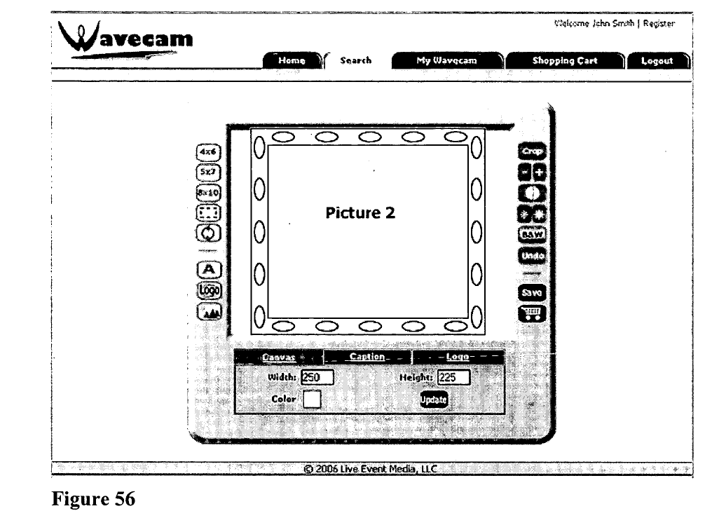

FIG. 56 shows an image with an embedded border containing a corporate logo. The corporate logo is added to the image using the NotDescriptor and the SubtractDescriptor of the Java Advanced Imaging API as described earlier in the watermarking operation. The image is displayed to the user and the user cannot see the image without the border.

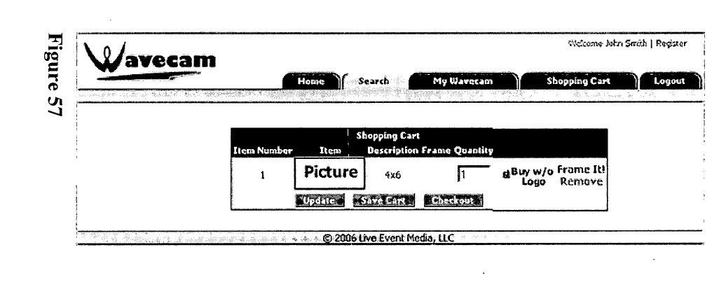

FIG. 57 shows the shopping cart. There is a checkbox that allows the user to remove the corporate logo border. This increases the price of the image.

FIGS. 58-63 are sample pictures that appear in selected user interface display screens.

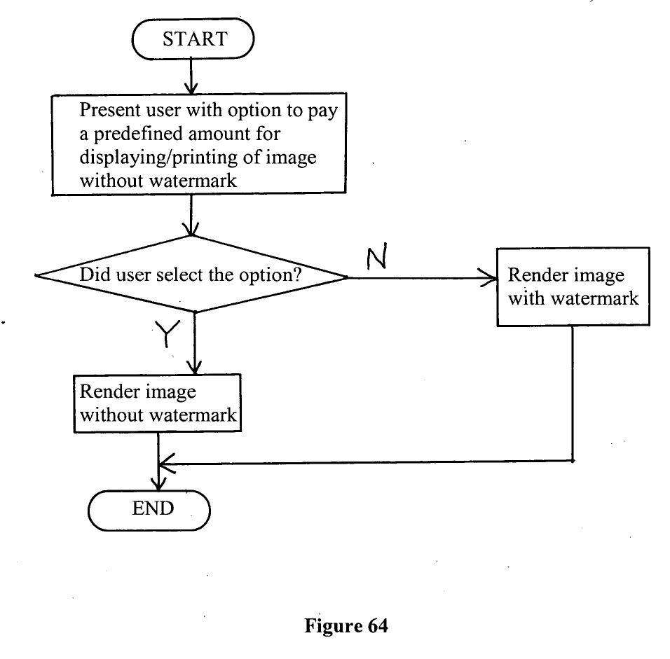

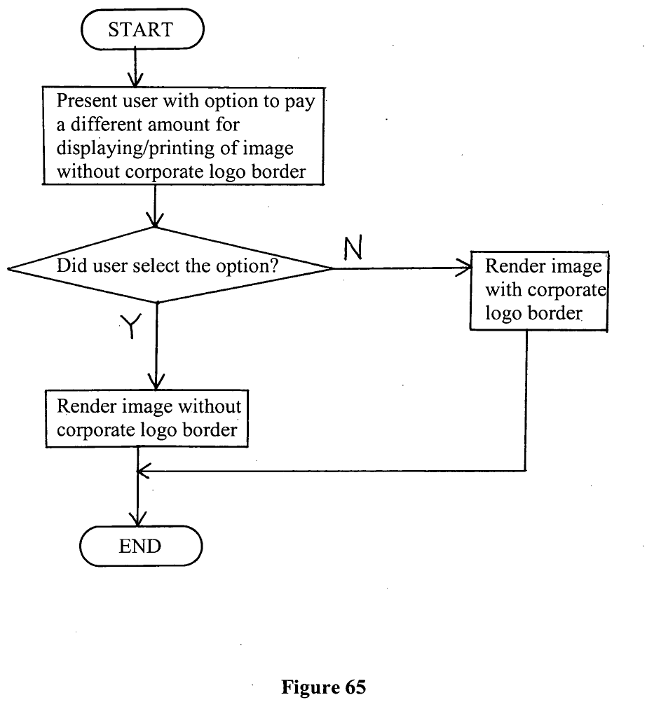

FIGS. 64 and 65 are self-explanatory flowcharts for an image watermark process and a corporate logo border image process, respectively.

In one preferred embodiment of the present invention, a watermark and/or a corporate logo border is automatically added to each displayed image. If a corporate logo border is provided, the host web site would receive some form of monetary compensation from the corporate sponsor, thereby allowing the host web site to permit users to display, store and/or print out images at either no cost or at a reduced cost. The watermark discourages users from storing and/or printing out images. The watermark can alternatively take the form of a corporate logo.

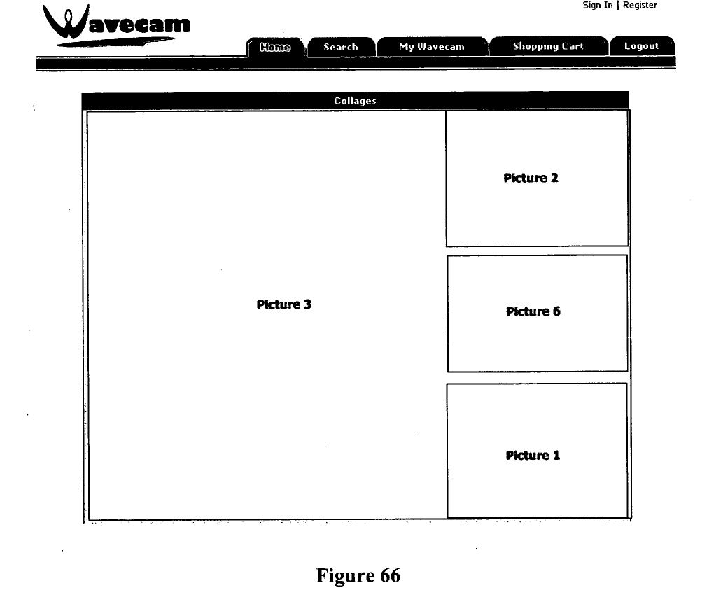

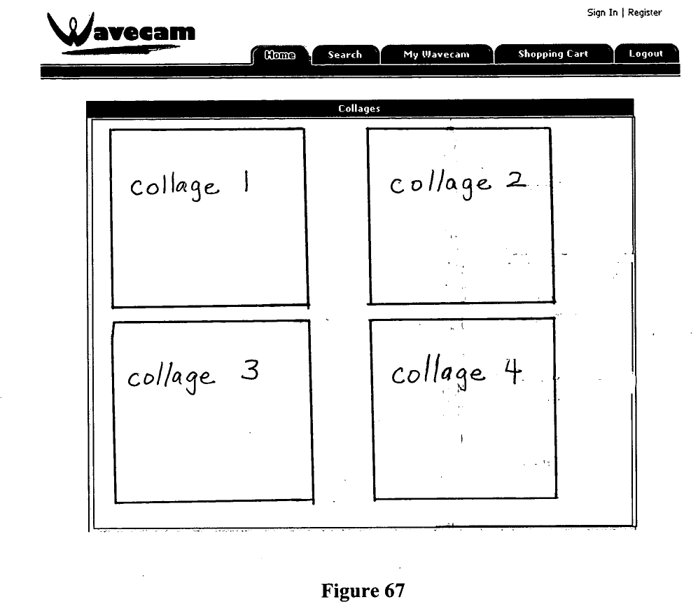

Following the steps above, the user may also choose an “auto-collage” feature which combines several images together. FIG. 66 shows the results of the user selecting Picture 3 and clicking on the auto collage button. The system automatically combines Picture 3 with a variable number of other images (in this case, three images) from the same seating section and/or from the event (e.g., event performers). Using the functionality in the Java Advanced Imaging API, Picture 3 is used as the base picture and is displayed full size. The system then crops and scales Pictures 2, 6, and 1 and embeds them within Picture 3. The system will display several different collage options for the user to choose from. The collage options may be selected either before creation of the collage, or a plurality of different collages may be automatically created and displayed to the user, as shown in FIG. 67. The user can then choose to further edit the collage through the image editing interface or can choose to purchase the collage, as is. Collages can be created from (i) the user selected picture and additional pictures in the same seating section (which presumably would also include the user); (ii) the user selected picture, additional pictures in the same seating section, and event performers; or (iii) the user selected picture and event performers. Additional images may be included that represent the event, such as ticket stubs or advertising-related images.

Some conventional photo editing software includes an auto-collage feature. However, in such software, the user must deliberately select each of the images to be included in the collage and then the software automatically creates the collage. In the auto-collage feature of the present invention, the user does not deliberately select each of the images. In one preferred embodiment described above, the user only selects one image and the system automatically selects the remaining images. This scheme simplifies the collage creation process for the user.

In one preferred embodiment of the present invention, all of the image operations occur at the host web site, and rendered images are sent to the user's browser. When a user selects an image operation, a request to perform the image operation is sent from the user's browser to the host web site where the image operation is performed on the image. An updated rendered image is then sent back to the user's browser.

In the preferred embodiment of the present invention wherein a watermark and/or a corporate logo border is added to each displayed image, the image operation(s) for imposing the watermark and/or corporate logo border occurs automatically as the first image operation, and occurs before the rendered image is sent to the user. Thus, the watermark and/or corporate logo appears when the image is first rendered and viewed by the user. Subsequent image operations are controlled by the user and occur only if selected by the user. However, if the user selects a higher payment option, no watermark and/or a corporate logo border would be imposed on the initially rendered image, or on subsequently rendered images.

In one preferred embodiment of the present invention, the above-described system is used in conjunction with an aerial support structure and method for image capture,” such as described in copending U.S. application Ser. No. 11/470,461 filed Sep. 6, 2006.

The present invention may be implemented with any combination of hardware and software. If implemented as a computer-implemented apparatus, the present invention is implemented using means for performing all of the steps and functions described above.

The present invention can be included in an article of manufacture (e.g., one or more computer program products) having, for instance, computer useable media. The media has embodied therein, for instance, computer readable program code means for providing and facilitating the mechanisms of the present invention. The article of manufacture can be included as part of a computer system or sold separately.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention.

What is claimed is:

1. A computer-implemented method of allowing a user to locate, edit and print images of event participants in attendance at a plurality of different event venues, the method comprising:
(a) providing a venue database containing data for a plurality of venues, the venue database including for each venue:
(i) past events that occurred at the venue for a predetermined past time period and the associated event date,
(ii) a venue seating chart,
(iii) event participant images captured at past events at a plurality of different seating locations;
(b) the user searching the data in the venue database to identify a past event of interest;
(c) displaying a venue seating chart associated with the past event of interest;
(d) the user selecting a seating location on the seating chart;
(e) displaying one or more event participant images captured at the past event of interest at the selected seating location;
(f) the user selecting one or more of the images;
(g) providing a plurality of different image editing functions to a user on a user interface display screen; and
(h) the user applying one or more of the image editing functions to the one or more selected images via the user interface display screen.

2. The method of claim 1 further comprising:
(i) printing the one or more edited images.

3. The method of claim 1 wherein the data in the venue database includes data related to the event type for at least some of the past events, and step (b) further includes the user searching the data in the venue database using event type as a search field.

4. A computer-implemented method of allowing a user to edit and print images of event participants in attendance at an event venue, the method comprising:
(a) providing an image database that includes event participant images captured at past events at the event venue;
(b) the user selecting one or more of the images;
(c) providing a plurality of different image editing functions to the user on a user interface display screen;
(d) the user applying one or more of the image editing functions to the one or more selected images via the user interface display screen;
(e) storing in an image database:
(i) an identifier of each image that was edited, and
(ii) each of the different image editing functions applied to the one or more selected images; and
(f) printing edited images at a remote image printing location by:
(i) using the identifier to retrieve an unedited version of the one or more selected images that were edited on the user interface display screen, and
(ii) applying the same image editing functions to the one or more selected images as were applied via the user interface display screen.

5. The method of claim 4 wherein if more than one image editing function is applied, step (e) further comprises storing:
(iii) the order of application of the different image editing functions,
wherein step (f)(ii) further comprises applying the same image editing functions to the one or more selected images in the same order of application.

6. The method of claim 4 further comprising:
(g) presenting and selecting a plurality of framing options for the edited one or more selected images via the user interface display screen;
(h) storing the user's selected framing option in a remotely accessible database;
(i) retrieving the user's framing option at the remote image printing location from the remotely accessible database so that the printed one or more images can be framed with the user's selected frame.

7. A computer-implemented method of editing and printing images, the method comprising:
(a) providing an image database that includes a plurality of images;
(b) a user selecting one or more of the images;
(c) providing a plurality of different image editing functions to the user on a user interface display screen;
(d) the user applying one or more of the image editing functions to the one or more selected images via the user interface display screen;
(e) storing in an image database:
(i) an identifier of each image that was edited, and
(ii) each of the different image editing functions applied to the one or more selected images; and
(f) printing edited images at a remote image printing location by:
(i) using the identifier to retrieve an unedited version of the one or more selected images that were edited on the user interface display screen, and
(ii) applying the same image editing functions to the one or more selected images as were applied via the user interface display screen.

8. The method of claim 7 wherein if more than one image editing function is applied, step (e) further comprises storing:
(iii) the order of application of the different image editing functions, wherein step (f)(ii) further comprises applying the same image editing functions to the one or more selected images in the same order of application.

9. The method of claim 7 further comprising:
(g) presenting and selecting a plurality of framing options for the edited one or more selected images via the user interface display screen;
(h) storing the user's selected framing option in a remotely accessible database;
(i) retrieving the user's framing option at the remote image printing location from the remotely accessible database so that the printed one or more images can be framed with the user's selected frame.

10. A computer-implemented method of processing images retrieved from a remote location, the method comprising:
(a) providing a remote image database including a plurality of images, the remote image database being accessible via an electronic network;
(b) providing a browser-based user interface display screen at a user location that can request and retrieve selected images in the remote image database via the electronic network;
(c) the user selecting an image from the remote image database for display on the display screen; and
(d) automatically and electronically imposing a border around the image, the border including a logo.

11. The method of claim 10 further comprising:
(e) printing the image at an image printer, the printed image including the border.

12. The method of claim 10 wherein the border is electronically imposed in a non-removable manner.

13. A computer-implemented method of processing images retrieved from a remote location, the method comprising:
(a) providing a remote image database including a plurality of images, the remote image database being accessible via an electronic network;
(b) providing a browser-based user interface display screen at a user location that can request and retrieve selected images in the remote image database via the electronic network;
(c) the user selecting an image from the remote image database for display on the display screen;
(d) providing an image operation that electronically imposes a non-removable border around the image;
(e) providing the ability to activate or deactivate the image operation;
(f) establishing an electronic payment process for allowing a user to pay for printing images via the electronic network, the electronic payment process including a first option for printing images without the border around the image; and
(g) if the user selects the first option, deactivating the image operation so that no non-removable border is imposed around the image.

14. The method of claim 13 wherein step (f) further comprises a second option for printing images with the non-removable border around the image, the method further comprising:
(h) if the user selects the second option, activating the image operation so that the non-removable border is imposed around the image.

15. The method of claim 14 wherein the second option is a default option so that selection of the second option automatically occurs by not selecting the first option.

16. The method of claim 14 further comprising:
(i) allowing the image to be printed at an image printer, the printed image not including the border if the user selected the first option, and the printed image including the border if the user selected the second option.

17. The method of claim 14 wherein the first option has a higher cost than the second option.

18. The method of claim 13 wherein the border includes a corporate logo.

19. A computer-implemented method of processing images retrieved from a remote location, the method comprising:
(a) providing a remote image database including a plurality of images, the remote image database being accessible via an electronic network;
(b) providing a browser-based user interface display screen at a user location that can request and retrieve selected images in the remote image database via the electronic network;
(c) the user selecting an image from the remote image database for display on the display screen;
(d) providing an image operation that electronically imposes a watermark on the image;
(e) providing the ability to activate or deactivate the image operation;
(f) establishing an electronic payment process for allowing a user to pay for printing images via the electronic network, the electronic payment process including a first option for printing images without the watermark; and
(g) if the user selects the first option, deactivating the image operation so that no watermark is imposed on the image.

20. The method of claim 19 wherein step (f) further comprises a second option for printing images with the watermark imposed on the image, the method further comprising:
(h) if the user selects the second option, activating the image operation so that the watermark is imposed on the image.

21. The method of claim 20 wherein the second option is a default option so that selection of the second option automatically occurs by not selecting the first option.

22. The method of claim 20 further comprising:
(i) allowing the image to be printed at an image printer, the printed image not including the watermark if the user selected the first option, and the printed image including the watermark if the user selected the second option.

23. The method of claim 20 wherein the first option has a higher cost than the second option.

24. A computer-implemented method of producing a collage from images retrieved from a remote location, the method comprising:
(a) providing a remote image database including a plurality of images, the remote image database being accessible via an electronic network, the images including event participants in attendance at an event venue, at least some of the images being associated with specific seating locations in the event venue;
(b) providing a browser-based user interface display screen at a user location that can request and retrieve selected images in the remote image database via the electronic network;
(c) the user selecting an image from the remote image database for display on the display screen, the selected image being associated with a specific seating location in the event venue;
(d) the user selecting a collage creation operation via the user interface; and
(e) automatically creating one or more collages of images for display on the display screen, each collage including the image selected by the user and at least one additional image associated with the same or adjacent seating location in the event venue as the user selected image, wherein at least one of the images in each collage is an image that the user did not deliberately select.

25. The method of claim 24 further comprising:
(f) the user selecting one of the collages for subsequent image storage or image printing.

26. The method of claim 24 wherein the remote image database further includes images of event performers, and step (e) further comprises including one or more images of event performers in the collage.

27. A computer-implemented method of producing a collage from images retrieved from a remote location, the method comprising:
(a) providing a remote image database including a plurality of images, the remote image database being accessible via an electronic network, the images including event participants ih attendance at an event venue and event performers;
(b) providing a browser-based user interface display screen at a user location that can request and retrieve selected images in the remote image database via the electronic network;
(c) the user selecting an image from the remote image database for display on the display screen;
(d) the user selecting a collage creation operation via the user interface; and
(e) automatically creating one or more collages of images for display on the display screen, each collage including the image selected by the user and at least one additional image of an event performer, wherein at least one of the images in each collage is an image that the user did not deliberately select.

28. The method of claim 27 further comprising:
(f) the user selecting one of the collages for subsequent image storage or image printing.
